(19) United States
(12) Patent Application Publication
(10) Pub. No.: US 2011/0288783 A1
(43) Pub. Date: Nov. 24, 2011

(54) SYSTEM FOR PREDICTING DRUG EFFECTS AND ADVERSE EFFECTS AND PROGRAM FOR THE SAME

(75) Inventors: Masaaki Oka, Ube-Shi (JP); Yoshihiko Hamamoto, Ube-Shi (JP); Shouichi Hazama, Ube-Shi (JP); Yusuke Fujita, Ube-Shi (JP); Ryouichi Tsunedomi, Ube-Shi (JP)

(73) Assignees: Toyo Kohan Co., Ltd., Tokyo (JP); YAMAGUCHI UNIVERSITY, Yamaguchi-shi (JP)

(21) Appl. No.: 13/150,834

(22) Filed: Jun. 1, 2011

Related U.S. Application Data
(63) Continuation of application No. PCT/JP2009/006520, filed on Dec. 1, 2009.

(30) Foreign Application Priority Data
Dec. 1, 2008 (JP) 2008-306916

(51) Int. Cl. G06F 19/10

(52) U.S. Cl. 702/19

(57) ABSTRACT

A drug effect-adverse effect prediction system includes a clinical data analysis table generating part, for each combination of genotypes relating to a drug effect or adverse effect, for generation of an analysis table for handling cases related to presence or absence of the drug effect or adverse effect. The system also includes a reliability analysis part, a discrimination formula generating part, a prediction part, and a discrimination formula optimizing part.

### CROSS-REFERENCE TO RELATED APPLICATIONS

This application is a continuation application of International Patent Application No. PCT/JP2009/006520 filed on Dec. 1, 2009, which claims priority to Japanese Patent Application No. 2008-306916 filed on Dec. 1, 2008 in Japan.

### BACKGROUND OF INVENTION

1. Field of the Invention

The present invention relates to a system and program, for each combination of genotypes occurring in a gene having a possibility of imparting a drug effect or adverse effect, for collecting of data relating to the presence-absence of effects or adverse effects occurring due to drug administration, and by combining genotypes, for constructing a discrimination formula relating to the occurrence of effects and adverse effects of the drug, and while increasing accuracy of this discrimination formula, for predicting with high reliability and general versatility effects and adverse effects of the drug due to a widened range of application.

2. Background Art

The difficulty of cancer treatment is said to be due to the diversity of cancers. Individualized medical treatment is demanded for cancer treatment. When an anti-cancer drug is administered for cancer treatment, the presence or absence of effects and the adverse effects vary from person to person. In the worse case, the anti-cancer drug may be ineffective and only have an adverse effect. Therefore, accurate prediction of drug effects and adverse effects during administration of a drug such as an anti-cancer drug or the like is extremely important for the determination of a diagnostic method for administration of the drug or the like.

Considerable research is being carried out concerning the relationship between genotypes and adverse effects and relating to the prediction of adverse effects of anti-cancer drugs. During previous research concerning the relationship between anti-cancer drugs and adverse effects, only a single genotype, or at most two genotypes, have been considered. Many investigations have not been carried out concerning combinations of three or more such genotypes (See Non-Patent Document 1 listed below).

Moreover, research is also being carried out on diagnostic methods based on the expression of a gene rather than gene polymorphism. Patent Document 1 describes a diagnostic method in which 52 significant genes are extracted from 384 candidate genes by separate Mann-Whitney U testing, a prediction score is calculated based on the degree of expression of the extracted 52 genes, and the diagnosis is based on the score value. However, the diagnostic ability using a single gene is low, and it is not possible to extract genes that have good diagnostic ability when combined together. Moreover, even if a single scoring formula is devised, since the problems of genes and gene polymorphism are complex, good diagnostic ability may be unobtainable when using only a single scoring formula.

A system is also being developed for supportive diagnosis using a database of clinical data.

Using the “diagnosis supportive system” disclosed in Patent Document 2, a search key is designated and data are searched corresponding to a database of genotypes, age, sex, or the like. A listing of such clinical data is tabulated, and it is possible to provide to the physician statistical data or clinical data that are highly significant concerning the effects and adverse effects of an anti-cancer drug. However, this system requires that the operator designate the search key, and highly reliable prediction is difficult when an effective search key for searching is not known.
Non-Patent Document 1: Sai, Sawada, and Minami: Irinotecan Pharmacogenetics in Japanese Cancer Patients—Role UGT1A1 Gene Polymorphism (*6 and *28), Yakugaku Zasshi, 128 (4), 2008.
Patent Document 1: Japanese Patent Application Laid-Open Publication No. 2003-61678
Patent Document 2: Japanese Patent Application Laid-Open Publication No. 2005-202547

Due to the multi-faceted background of each individual patient, accurate prediction of drug effects and adverse effects is difficult. Moreover, the effect and adverse effect operational mechanisms are complex, and the prediction of drug effects and adverse effects is difficult when using just one genotype, or at most 2 genotypes, as has been done conventionally. If drug effects and adverse effects could be predicted by a combination of a larger number of factors, then diagnosis would be expected to be possible that has higher reliability and general versatility.

Moreover, using the conventional supportive diagnosis system that uses the database of clinical data, the operator must designate the search key, must search the data corresponding to the database, and must predict anti-cancer drug effects and adverse effects based on the search of the related clinical data. However, the search key must be designated by the operator, and when a useful search key for prediction is not clear, highly reliable prediction is difficult. If a targeted discrimination formula could be automatically constructed, drafting of a search formula by the operator would become unnecessary, and it would be possible to efficiently use data that is highly reliable and generally versatile.

### SUMMARY OF INVENTION

Due to the multi-faceted background of each individual patient, accurate prediction of drug effects and adverse effects is difficult. Moreover, the effect and adverse effect operational mechanisms are complex, and the prediction of drug effects and adverse effects is difficult when using just one genotype, or at most 2 genotypes, as has been done conventionally. If drug effects and adverse effects could be predicted by a combination of a larger number of factors, then diagnosis would be expected to be possible that has higher reliability and general versatility.

Moreover, using the conventional supportive diagnosis system that uses the database of clinical data, the operator must designate the search key, must search the data corresponding to the database, and must predict anti-cancer drug effects and adverse effects based on the search of the related clinical data. However, the search key must be designated by the operator, and when a useful search key for prediction is not clear, highly reliable prediction is difficult. If a targeted discrimination formula could be automatically constructed, drafting of a search formula by the operator would become unnecessary, and it would be possible to efficiently use data that is highly reliable and generally versatile.

One or more embodiments of the claimed invention are directed to a system and program for predicting drug effects and adverse effects with high reliability and versatility, and that automatically generates a discrimination formula for prediction based on a combination of genotypes thought to be related according to the object of the prediction, e.g., drug effect, adverse effect, or the like.

Moreover, in addition to genotypes, factors such as sex, age, gene expression, etc. may be used in analyses of one or more embodiments of the claimed invention.

In one or more embodiments of the claimed invention, the drug effect-adverse effect prediction system includes: a clinical data analysis table generating part, for each combination of genotypes (referred to hereinafter as the “gene conditions”) relating to a drug effect or adverse effect, for generation of an analysis table for handling cases related to presence or absence of the drug effect or adverse effect; a reliability analysis part for selecting at least one of the gene conditions from among the gene conditions in the analysis table and calculating a share rate for a case count concerning the presence or absence of the effect or adverse effect; a discrimination formula generating part for extracting corresponding gene conditions from the gene conditions resulting from the share rate calculated by the reliability analysis part based on a desired threshold value for the share rate and a desired threshold value for presence or absence in the case count, and for generating a discrimination formula using the extracted gene condition either as the single extracted gene condition or as a combination of the extracted gene conditions; a prediction part, for each gene condition included in the discrimination formula, for performing comparison checking of data relating to the genotype of a specimen relating to the presence or absence of the drug effect or adverse effect and for predicting absence or presence of the drug effect or adverse effect of the specimen based on matching with the discrimination formula; and a discrimination formula optimizing part including: a function for appending to the discrimination formula generated by the discrimination formula generating part by addition of the gene condition relevant to the desired threshold value relative to the case count from among the gene conditions extracted by the discrimination formula generating part, and for selecting the gene condition that increases the share rate or case count in the appended overall discrimination formula; and/or a function for selection and deletion of the gene condition increasing the share rate or case count in a decreased overall discrimination formula resulting from reduction from the generated discrimination formula.

According to the above described drug effect-adverse effect prediction system, the case analysis table generating part has a function for generating a table (summary table) corresponding to each gene condition concerning cases relating to the presence or absence effects or adverse effects of the drug, and the reliability analysis part has a function for selecting at least one gene condition from among the gene conditions of the table and for calculating the share rate concerning number of cases of the presence or absence of the effect or adverse effect. The discrimination function generating part has a function for extracting corresponding gene conditions based on the threshold value for the share rate and has a function for generation of the discrimination formula. The gene conditions included in this discrimination formula become information for prediction of the presence or absence of the effect or adverse effect of the drug.

Moreover, according to the drug effect-adverse effect prediction system in one or more embodiments of the claimed invention, the discrimination formula generating part, based on the desired threshold for the share rate and the desired threshold value for presence or absence of the case count, extracts corresponding gene conditions from the gene conditions for which the share rate was calculated by the reliability analysis part, and generates the discrimination formula by using the extracted gene condition either as a single gene condition or a combination of the gene conditions.

According to this drug effect-adverse effect prediction system, the discrimination formula generating part extracts the gene conditions based also on the threshold for the presence or absence of the case count, rather than just based on the desired threshold value for the share rate.

In one or more embodiments of the claimed invention, the drug effect-adverse effect prediction system has a discrimination formula optimizing part that includes: a function for appending to the discrimination formula generated by the discrimination formula generating part by addition of the gene condition relevant to the desired threshold value relative to the case count from among the gene conditions extracted by the discrimination formula generating part, and for selecting the gene condition that increases the share rate or case count in the appended overall discrimination formula; and/or a function for selection and deletion of the gene condition increasing the share rate or case count in a decreased overall discrimination formula resulting from reduction from the generated discrimination formula.

According to this drug effect-adverse effect prediction system, the discrimination formula optimizing part has a function for appending to the discrimination formula generated by the discrimination formula generating part by addition of the gene condition relevant to the desired threshold value relative to the case count from among the gene conditions extracted by the discrimination formula generating part, and for selecting the gene condition that increases the share rate or case count in the appended overall discrimination formula; or conversely has a function for selection and deletion of the gene condition increasing the share rate or case count in a decreased overall discrimination formula resulting from reduction from the generated discrimination formula.

Furthermore, in one or more embodiments of the claimed invention, for the drug effect-adverse effect prediction system, when the share rate and cases of a first gene condition are identical with the share rate and cases of another gene condition, from among the gene conditions included in the generated discrimination formula, the discrimination formula optimizing part deletes the other gene condition from the generated discrimination formula.

Using the drug effect-adverse effect prediction system of the above described configuration, in addition to the functions of the above mentioned embodiments, the discrimination formula optimizing part has a function, when a case of a gene condition and an share rate for gene condition having had share rates calculated by the discrimination formula optimizing part using a different discrimination formula are the same; and the discrimination formula optimizing part also has a function for deletion from the discrimination formula of one of the different discrimination formulae.

In one or more embodiments of the claimed invention, the drug effect-adverse effect prediction system uses the drug effect-adverse effect prediction system; where the discrimination formula optimizing part further includes: a function for reading a condition (referred to hereinafter as the “medical knowledge condition”) based on medical knowledge relating to the presence or absence of the drug effect-adverse effect contained beforehand in a database, searching the extracted gene conditions, and subtracting the medical knowledge condition when the extracted gene conditions include the medical knowledge condition; and a function for adding the medical knowledge condition when the medical knowledge condition is not included in the extracted gene conditions.

In addition to the functions of the above mentioned embodiments, the drug effect-adverse effect prediction system having this configuration has a function for the discrimination formula optimization part appending or deleting the medical knowledge condition.

In one or more embodiments, the drug effect-adverse effect prediction system uses the drug effect-adverse effect prediction system were the case analysis table generating part adds to the analysis table data relating to the gene condition of the specimen while classifying the added data concerning presence or absence of the drug effect or adverse effect; the reliability analysis part reads the analysis table, selects at least one of the gene conditions, and calculates the share rate; the discrimination formula generating part, based on the desired threshold value for the share rate and the desired threshold value for presence or absence of the case count, extracts the gene condition and generates the discrimination formula using the gene condition alone or the combined gene conditions; and the prediction part predicts an overall share rate in the generated discrimination formula for an estimated value of the reliability that has been classified relating to presence or absence of the drug effect or adverse effect for the specimen.

According to the drug effect-adverse effect prediction system configured in this manner, the prediction part has a function for prediction by calculation of an estimated value relating to presence or absence of the drug effect or adverse effect for the specimen.

The drug effect-adverse effect prediction program that is the invention mentioned in claim 9 uses a computer for prediction of a drug effect-adverse effect; where the computer performs: a case analysis table generating step of generating an analysis table for handling cases related to presence or absence of the drug effect or adverse effect for each of gene condition relating to the drug effect or adverse effect; a reliability analyzing step of selecting at least one gene condition from among the gene conditions in the analysis table and calculating a share rate of a case count of the presence or absence of the effect or adverse effect; a discrimination formula generating step, based on a desired threshold value for the share rate and a desired threshold value for presence or absence of the case count, of extracting of corresponding gene conditions from among the gene conditions having had share rates calculated during the reliability analysis step, and of generating a discrimination formula using a single extracted gene condition or a combination of extracted gene conditions; a predicting step of prediction relating to the presence or absence of the drug effect or adverse effect of the specimen based on, for each of the gene conditions included in the discrimination formula, comparison checking of data relating the gene condition of a specimen relating to presence or absence of the drug effect or adverse effect, and arranging the discrimination formula; and a discrimination formula optimizing step including: a step of appending to the discrimination formula generated by the discrimination formula generating part by addition of the gene condition relevant to the desired threshold value relative to the case count from among the gene conditions extracted by the discrimination formula generating part, and selecting the gene condition that increases the share rate or case count in the appended overall discrimination formula; and/or a step of selecting and deleting of the gene condition increasing the share rate or case count in a decreased overall discrimination formula resulting from reduction from the generated discrimination formula.

The drug effect-adverse effect prediction program configured in this manner has effects similar to those of the above mentioned embodiments.

According to the drug effect-adverse effect prediction program in one or more embodiments, during the discrimination formula generating step, based on the desired threshold for the share rate and the desired threshold value for presence or absence of the case count, corresponding gene conditions are extracted from the gene conditions for which the share rate was calculated by the reliability analysis part, and the discrimination formula is generated by using the extracted gene condition either as a single gene condition or a combination of the gene conditions.

The drug effect-adverse effect prediction program configured in this manner has effects similar to those of the above mentioned embodiments.

In one or more embodiments of the claimed invention, the drug effect-adverse effect prediction program has a discrimination formula optimizing part that includes: a step of appending to the discrimination formula generated by the discrimination formula generating part by addition of the gene condition relevant to the desired threshold value relative to the case count from among the gene conditions extracted by the discrimination formula generating part, and of selecting the gene condition that increases the share rate or case count in the appended overall discrimination formula; and/or a step for selection and deletion of the gene condition increasing the share rate or case count in a decreased overall discrimination formula resulting from reduction from the generated discrimination formula.

The drug effect-adverse effect prediction program configured in this manner has effects similar to those of the above mentioned embodiments.

In one or more embodiments of the claimed invention, the drug effect-adverse effect prediction program is the drug effect-adverse effect prediction program; where during the discrimination formula optimizing step, when the share rate and cases of a first gene condition are shared with the share rate and cases of another gene condition, from among the gene conditions included in the generated discrimination formula, the discrimination formula optimizing part deletes the other gene condition from the generated discrimination formula.

The drug effect-adverse effect prediction program configured in this manner has effects similar to those of the above mentioned embodiments.

In one or more embodiments of the claimed invention, the drug effect-adverse effect prediction program is the drug effect-adverse effect prediction program; where the discrimination formula optimizing step further includes: a step of reading a condition (referred to hereinafter as the “medical knowledge condition”) based on medical knowledge relating to the presence or absence of the drug effect-adverse effect contained beforehand in a database, searching the extracted gene conditions, and subtracting the medical knowledge condition when the extracted gene conditions include the medical knowledge condition; and a step of adding the medical knowledge condition when the medical knowledge condition is not included in the extracted gene conditions.

The drug effect-adverse effect prediction program configured in this manner has effects similar to those of the above mentioned embodiments.

In one or more embodiments of the claimed invention, the drug effect-adverse effect prediction program is the drug effect-adverse effect prediction program; where the case analysis table generating step adds to the analysis table data relating to the gene condition of the specimen while classifying the added data concerning presence or absence of the drug effect or adverse effect; the reliability calculating step reads the analysis table, extracts at least one of the gene read conditions, and calculates the share rate; the discrimination formula generating step, based on the desired threshold value for the share rate and the desired threshold value for presence or absence of the case count, extracts the gene condition and generates the discrimination formula using the gene condition alone or a combination of the gene conditions; and the prediction step predicts an overall share rate in the generated discrimination formula for an estimated value of the reliability that has been classified relating to presence or absence of the drug effect or adverse effect for the specimen.

The drug effect-adverse effect prediction program configured in this manner has effects similar to those of the above mentioned embodiments.

According to the drug effect-adverse effect prediction system in one or more embodiments of the claimed invention, according to the object of prediction of the drug effect-adverse effect or the like, the discrimination formula is generated automatically by combinations of a large amount of gene conditions and clinical data, and it is possible to perform prediction while attaining high reliability and general versatility.

Due to the discrimination formula used for prediction being automatically generated based on data relating to the clinical data, prediction can be readily performed even when the operator has no specialized knowledge relating to drugs and effects-adverse effects. The genotype is considered as a factor used for the gene condition.

According to the drug effect-adverse effect prediction system in one or more embodiments of the claimed invention, due to the ability to generate the discrimination formula by combination of gene conditions combining the conventional small number of factors and by combination of gene conditions combining a larger number of factors, it is possible to attain a prediction system that surpasses the capabilities of previous prediction systems. Moreover, due to the generation of the discrimination formula by OR logic calculation using multiple gene conditions, it is possible to design a prediction system that has great general versatility. Also based on statistics of the data accumulated in the clinical data database, it is possible to provide confidence values separately for prediction results. Furthermore, based on the introduction of medical knowledge rather than just designing the discrimination formula by simple technical combination of factors, it is possible to design a discrimination formula that has further increased reliability.

In particular, one or more embodiments of the claimed invention use fixed logic for execution of the addition and/or deletion of the gene conditions constituting the discrimination formula, and after a discrimination formula has been generated, it is thus possible to increase the share rate and clinical data count covered by the discrimination formula.

Moreover, according to one or more embodiments of the claimed invention, the discrimination formula can be generated efficiently by discarding redundant gene condition formulae. According to one or more embodiments of the claimed invention, generation of a discrimination formula is also possible that reflects medical knowledge conditions, and prediction is possible that reflects such medical knowledge conditions. According to one or more embodiments of the claimed invention, when prediction is not possible from some reason, it is possible to make an estimate based on specimen data.

Other aspects and advantages of the invention will be apparent from the following description and the appended claims.

### BRIEF DESCRIPTION OF DRAWINGS

FIG. 1 is a conceptual drawing of the drug effect-adverse effect prediction system according to an embodiment of the present invention.

FIG. 2 is a conceptual drawing showing the relationships between factors, gene conditions, and the discrimination formula relating to genotypes used in the drug effect-adverse effect prediction system of the present embodiment.

FIG. 3 is a flowchart showing processing to generate the discrimination formula according to the drug effect-adverse effect prediction system of the present embodiment.

FIG. 4 is a flowchart showing the procedure of combining and optimizing executed by the discrimination formula optimizing part of the drug effect-adverse effect prediction system of the present embodiment.

FIG. 5 shows an example of shifting of the optimized combination and performance of the gene conditions due to execution using the drug effect-adverse effect prediction system of the present embodiment and due to combination and optimization of the gene conditions.

FIG. 6 is a conceptual drawing of application for the drug effect-adverse effect prediction system of the present embodiment to clinical data for the presence or absence of an adverse effect when genotypes are combined in the case of two genotypes, A (Homo, Hetero, Wild) and B (Homo, Hetero, Wild).

FIG. 7 is a conceptual drawing showing the method for estimating reliability using the drug effect-adverse effect prediction system of the present embodiment when the determination has withheld.

### DETAILED DESCRIPTION

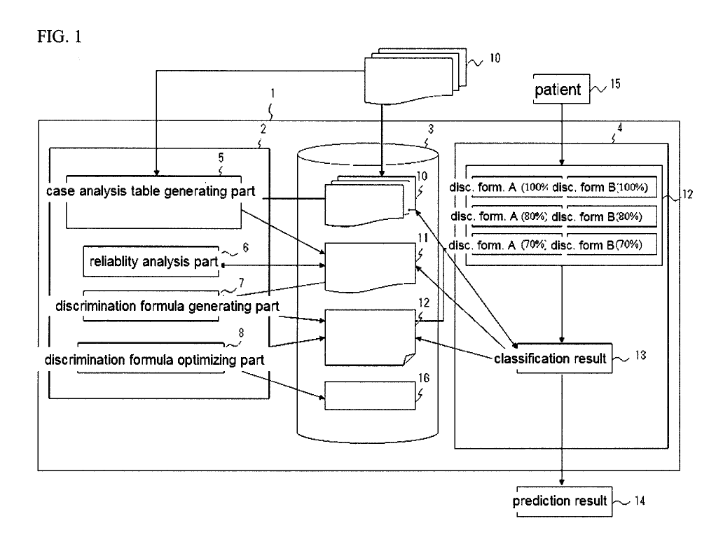

The drug effect-adverse effect prediction system of one or more embodiments of the present invention will be explained below in reference to FIG. 1 through FIG. 7.

FIG. 1 is a structural diagram of the drug effect-adverse effect prediction system of an embodiment of the present invention.

The drug effect-adverse effect prediction system 1 of the present embodiment is predominantly constituted by a discrimination formula design part 2, a prediction part 4, and a database 3.

The discrimination formula design part 2 includes a clinical data analysis table generating part 5, a reliability analysis part 6, a discrimination formula generating part 7, and a discrimination formula optimizing part 8.

The database 3 contains data firstly as data on the presence or absence or the like of drug effects or adverse effects accumulated previously by medical organizations or research organizations. The database 3 further contains clinical data on the sex, age, residence, drug administration history (including at least drug names, dosages, administration times, and administration time intervals) or the like attribute data. An analysis table 11 generated by the clinical data analysis table generating part 5, a discrimination formula data 12 generated by the discrimination formula generating part 7, and a medical knowledge condition 16 can be stored for reading from the discrimination formula design part. The medical knowledge condition 16 is a condition based on medical knowledge concerning the presence or absence of a drug effect-adverse effect. The medical knowledge condition 16 is contained beforehand in a database 3 as a condition of clinically high reliability or low reliability, or the medical knowledge condition 16 is input by the discrimination formula optimizing part 8 of the discrimination formula design part 2. The clinical data 10 may be input directly into the database 3, or alternatively, may be input by the clinical data analysis table generating part 5 of the discrimination formula design part 2 during generation of the analysis table 11 and then contained in the database 3. If the clinical data 10 are contained beforehand in the database 3, then the clinical data analysis table generating part 5 reads the clinical data 10 and generates the analysis table 11.

Using the prediction part 4, the desired discrimination formula data 12 are read out from the database 3, the input of genotype combination data (gene condition data) relating to the patient 15 for whom a prediction is desired concerning the presence or absence of an effect or adverse effect due to drug administration is received, or alternatively, such data contained beforehand in the database 3 are read out, and a comparison check is made with the combination of genotypes occurring in this discrimination formula. Then, classification of consistency with the discrimination formula is made, the result of classification is generated as the classification result 13, and a prediction result 14 is output based on this classification result 13.

The prediction result 14 may be output by including a transmission device or the like capable of transmission or the like to a display device or other equipment (e.g., LCD device or the like) in the drug effect-adverse effect prediction system 1 and connecting the transmission device to the prediction part 4, or alternatively, connecting to an independently arranged interface with the drug effect-adverse effect prediction system 1 at the time of use.

According to the drug effect-adverse effect prediction system 1 of the present embodiment, for example, gene conditions are prepared as ((a+1)ⁿ−1) combinations obtained by adding (a) types of genotypes and genotype non-designations generated for (n) respective types of genes, and the discrimination formula is generated by combination of these gene conditions.

Therefore, the clinical data 10 or the like become collected according to combinations prepared beforehand as gene conditions.

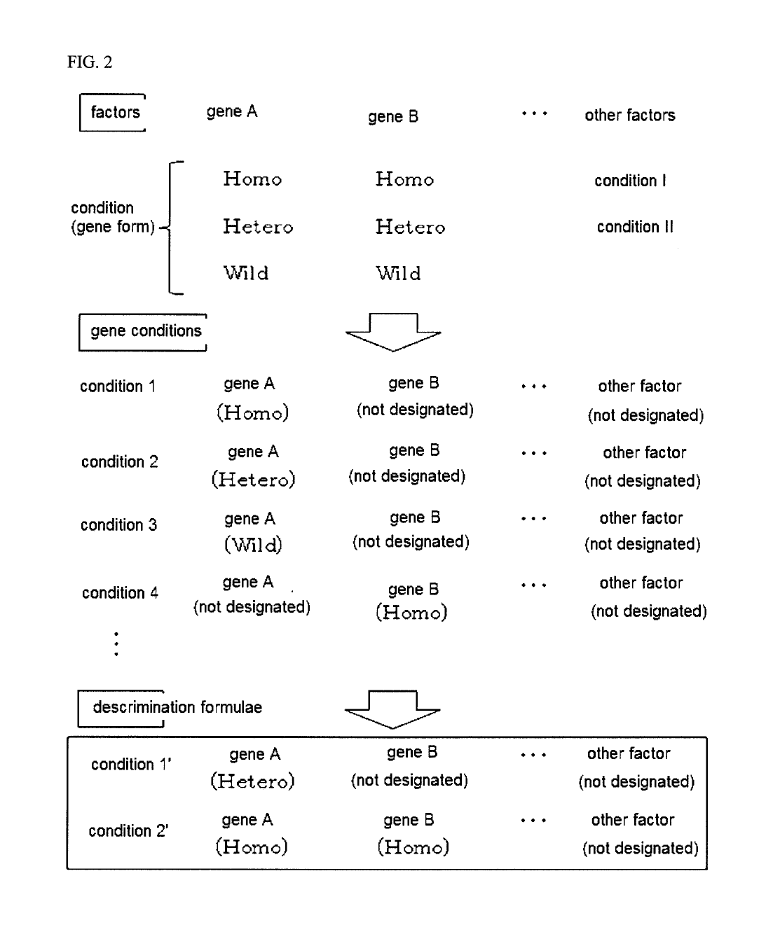

FIG. 2 shows the relationships between the factors, gene conditions, and discrimination formulae relating to the genotype used in the drug effect-adverse effect prediction system of the present embodiment.

The factors, gene conditions, and discrimination formula relating to the genotype will be explained separately in reference to FIG. 2.

The term “factor” will be explained first. FIG. 2 shows an example of genotypes. There are three types of genes in the present example, e.g., “Homo,” “Hetero,” and “Wild.” There are a total of 4 types, including the “undesignated” type.

The combinations of “gene conditions” in this case are firstly gene condition 1 (Homo form of gene A, gene B undesignated, and undesignated other factors), gene condition 2 (Hetero form of gene A, undesignated gene B, and undesignated other factor), or the like, e.g., the respective gene conditions of all combinations under investigation. As mentioned previously, this results in (a+1)ⁿ−1 combinations of gene conditions.

Although the clinical data 10 collects information on the presence or absence of an effect or adverse effect of a drug for each patient, the analysis table 11 corresponds to collection of such information for each gene condition. The gene conditions contain the respective individual factors or composites combining individual factors corresponding to the presence or absence of such effects-adverse effects, and the object of the gene conditions is to form data for the discrimination formula data 12 for the discrimination formula for prediction of the presence or absence of the drug effect-adverse effect. The “discrimination formula” shown in FIG. 2 is taken to be a single discrimination formula 1 with the combinations gene condition 1′ and gene condition 2′.

The discrimination formula will be explained somewhat further in reference to FIG. 1. The analysis table 11 is firstly generated reflecting the clinical data 10 for each the patient 15 concerning the presence or absence of effects-adverse effects for a drug with respect to these “gene conditions.” The reliability analysis part 6 analyzes the reliability (share rate) for at least one of the “gene factors.” The discrimination formula generating part 7, depending on the degree of reliability, generates the “discrimination formula,” to provide such a discrimination formula. The discrimination formula generated by the discrimination formula generating part 7 is stored in readable form in the database 3 as the discrimination formula data 12.

The discrimination formula contains a block or composite of gene conditions. Separate reliabilities (share rates) are calculated for each of the gene conditions included in the discrimination formula. The expression “degree of reliability” refers to the relationship with the arranged threshold value, including the clinical data counts corresponding to the extraction of individual gene conditions. These gene conditions satisfying the desired accuracy rate and coverage rate are collected to form the discrimination formula. Alternatively, it is possible to ignore the individual degrees of reliability of the gene conditions (share rates) and to calculate the overall reliability (share rate) and apply the threshold value to the clinical data corresponding to reliability (share rate) for the overall gene conditions, and it is possible to use a discrimination formula that bundles (forms a composite) of the gene conditions so that the bundle satisfies this degree of reliability. Alternatively, the simplest method that can be considered does not arrange a threshold value for the reliability (share rate) or clinical data count, but rather bundles all of the gene conditions and uses the combination to form the discrimination formula.

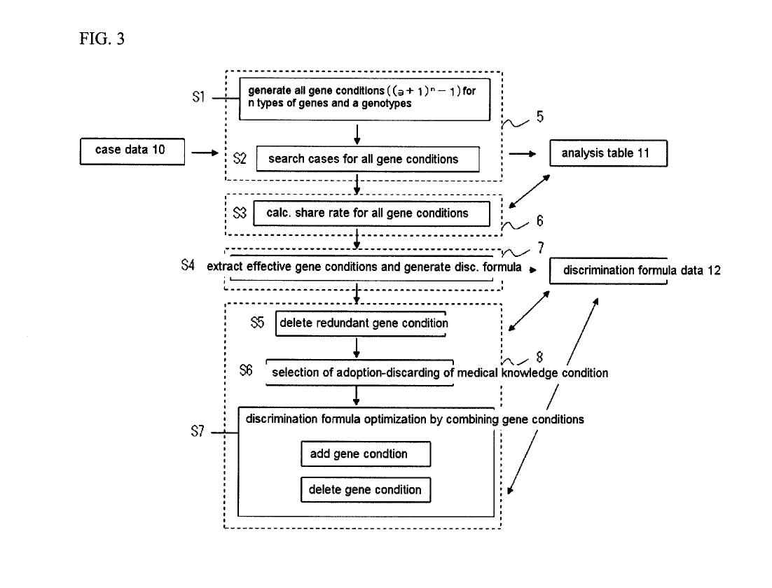

An example of the generation of this type of the discrimination formula will be explained in detail in reference to FIG. 3.

FIG. 3 is a flowchart showing the procedure of generation of the discrimination formula according to the drug effect-adverse effect prediction system 1 of the present embodiment. This figure uses a combination taking into account (a) types of genotypes and undesignated genotypes for each of (n) types of genes as factors.

The clinical data analysis table generating part 5 of the drug effect-adverse effect prediction system 1 of the present embodiment during step S1 generates as “gene conditions” ((a+1)ⁿ−1) combinations, which are obtained by adding the (a) types of genotypes and the undesignated genotype generated from of the separate (n) genotypes.

Because there are instances in which the undesignated genotype is including in the gene conditions generated by the clinical data analysis table generating part 5, among the gene conditions, gene conditions are also included that are formed from fewer than (n) genes. Thus, it is possible to use gene conditions in the discrimination formula when the gene conditions resulting from less than (n) genes are effective for categorization relating to the presence or absence of effects-adverse effects.

For example, in the case where the effective genes are only the 1st, 2nd, and 3rd genes among (n) types of genes, the nth genotype becomes categorized as “undesignated.” Due to a configuration that adds the undesignated type, including less than (n) genes, it is possible to generate gene conditions for all genes of the genotype.

Next, the clinical data analysis table generating part 5 during step S2 receives the clinical data 10 input, or reads clinical data 10 stored beforehand in the database 3, and checks clinical data counts relating to the presence or absence of effects or adverse effects for each of the genes.

At this time, various clinical data correspond to multiple gene conditions, i.e., duplicates are included.

While the clinical data analysis table generating part 5 generates “gene conditions” in this manner, clinical data 10 are examined for each of these gene conditions, and the analysis table 11 is generated to reflect the corresponding gene conditions.

The generated analysis table 11 is stored in the database 3.

There are 4 combination classifications resulting from presence/absence and the drug effect/adverse effect. The clinical data may be searched for each of these classifications.

Alternatively, according to use, the classifications for the clinical data analysis table generating part 5 may be set beforehand. Alternatively, a question asking which classification to check may be displayed by the display device or the like, and a classification may be input to the clinical data analysis table generating part 5 from among the candidate classifications.

Then, during step S3, the reliability analysis part 6 performs the calculation of the share rate. The clinical data item is classified, e.g., ineffective, effective, adverse effect, adverse effect-free, or the like. This share rate is taken to mean the count of clinical data included in such category labels divided by the total clinical data count. This share rate functions as an indication of reliability of a classification result. For example, checking the “adverse effect-free” classification, if 5 clinical data correspond to a certain “gene condition,” and if 4 clinical data among these have no adverse effect, the share rate for the classification label “adverse effect-free” for this gene condition becomes 80%. Thus, by calculating the share rate, it becomes possible to determine as effective gene conditions those gene conditions where the clinical data count corresponding to the “gene condition” is greater than or equal to (p) and where the share rate for the classification label is greater than or equal to r %. Due to setting of the clinical data count greater than or equal to (p), it is possible to raise the coverage rates of case counts corresponding to this gene condition, and it is possible to attain general versatility.

The reliability analysis part 6 calculates the share rates by directly using the analysis table 11 generated by the clinical data analysis table generating part 5, or alternatively, reads the analysis table 11 from the database 3 and then calculates the share rates.

Thereafter, during step S4, effective gene conditions are extracted for the classification. The effective gene conditions for this classification are extracted by the discrimination formula generating part 7. For example, the discrimination formula generating part 7 can perform extraction of effective gene conditions as those gene conditions, as mentioned above, where the clinical data count is greater than or equal to (p) and where the share rate of the classification label is greater than or equal to (r). The gene conditions extracted by the discrimination formula generating part 7 are combined to make the discrimination formula.

Specifically, a screen prompting the input of “p” as the threshold value of the clinical data count and input of “r” as the threshold of the share rate is displayed on a display device or the like (not shown in FIG. 1). Due to the input of these values into the drug effect-adverse effect prediction system 1, it becomes possible for the discrimination formula generating part 7 to select the “gene conditions” corresponding to such values. Alternatively, desired values of “p” and “r” can be stored beforehand in the database 3, and these values can be read out automatically. Alternatively, multiple desired values of “p” and “r” can be stored, and a configuration is possible in which these values are selected as parameters and are read out. In this manner, the matching “gene conditions” are selected, and these are combined to generate the “discrimination formula.” A threshold value for the clinical data count alone or for the share rate alone may be used, rather than threshold values for both the clinical data count and the share rate. However, upon consideration of the precision and range of application of the selection of gene conditions, the combination of threshold values is preferred. Moreover, since the value of this threshold affects the clinical data count content of the types of drugs and clinical data, it is not possible categorically to state what the magnitude of the threshold should be. The threshold is preferably determined appropriately as desired according to the object of the user, drug type, and the amount of the clinical data.

The selected “gene condition” may be a single gene condition, or as described above, may be a combination of such gene conditions. The single gene conditions or composites combining multiple gene conditions of these classification labels, as mentioned above, become the “discrimination formula.” The discrimination formula generating part 7 stores the discrimination formula 12 obtained in this manner in the read-capable database 3.

The number of “gene conditions” included in the “discrimination formula” is not fixed, and this number can vary according to the types of genes or genotypes. This number also varies according to the clinical data count and the share rate. Moreover, even when there is the same clinical data count or share rate, the combinations of the “gene conditions” constituting the “discrimination formula” are not fixed, and it is possible to arrange such combinations (step S5). Specifically, for a given clinical data count or share rate, generally the number of gene conditions constituting the discrimination formula is preferably low.

A specific example will be cited to explain this preference.

If a gene condition Q includes a gene condition P formed from two genotypes and a gene condition Q formed from three genotypes, and if the gene condition P and the gene condition Q are redundant for formation of a discrimination function, but the corresponding clinical data count and occupancy ratios are equal, then the gene condition P and the gene condition Q are considered redundant as gene conditions constituting the discrimination formula. Thus, in this type of case, the gene condition Q that has a larger number of genotypes is removed from the gene conditions candidates constituting the discrimination formula. For example, if there are five clinical data corresponding to a gene condition R ((gene A (Homo)) and (gene B (Homo))), and if there are the same clinical data corresponding to a gene condition S ((gene A (Homo)) and (gene B (Homo) and (gene C (Homo))), then these two gene conditions are seen to be redundant. In this case, the gene condition S that has the large number of combinations of factors (gene genotypes) is deleted from the collection of effective gene conditions. This type of calculation can be executed by using the discrimination formula optimizing part 8 to search the gene conditions constituting the discrimination formula.

As may be required, an arrangement is permissible that sifts out the gene conditions that have clinically highly reliability or gene conditions that have clinically low reliability from among the effective gene conditions (step S6). In this case, gene conditions are selected based on medical knowledge. Conditions (medical knowledge conditions 16) based on medical knowledge relating to the presence or absence of drug effects-adverse effects can be stored beforehand in the database 3, and such conditions can be read out by the discrimination formula optimizing part 8. These conditions are read by the discrimination optimizing part 8, the discrimination formula optimizing part 8 executes a search, and if this medical knowledge condition 16 is included in the discrimination formula, then this medical knowledge condition 16 is removed (when the medical knowledge condition 16 is a condition of low clinical reliability). Alternatively, if the medical knowledge condition 16 is not included in the discrimination formula, this medical knowledge condition 16 may be added (when the medical knowledge condition 16 is a condition of high clinical reliability). When the medical knowledge condition 16 is not included in the discrimination formula and then the medical knowledge condition 16 is added, the discrimination formula optimizing part 8 can be arranged to always add the medical knowledge condition 16, or alternatively to add a medical knowledge condition 16 that has satisfied certain conditions set beforehand within the discrimination formula optimizing part 8. The medical knowledge condition 16 can be read out from the database 3 so that the medical knowledge condition can be used within the discrimination formula optimizing part 8.

The term “medical knowledge condition” 16 refers to a condition, for example, specifically relating to knowledge such as that listed below, without limitation. Furthermore, the below described knowledge is current knowledge and may be subject to correction.

(1) An adverse effect occurs for the UGT1A1*28 (TA7/TA7) genotype when irinotecan is administered.

(2) There is no adverse effect when the patient has the Wild type.

(3) There is an adverse effect when the patient has the Homo type.

For example, when the (2) and (3) reverse gene conditions are included in the discrimination formula, the presence or absence of an adverse effect for each of these gene conditions may be doubtful. Therefore, due to introduction of the medical knowledge conditions, during generation of an adverse effect-free discrimination formula, it is possible to consider deletion of the gene condition including the Homo type, and it is possible to consider deletion of the gene condition including the Wild type.

Furthermore, this is an example of knowledge concerning an adverse effect, and it is not possible to say anything concerning prediction of an effect.

According to the present embodiment, deletion of a redundant gene condition constituting the discrimination formula and deletion or addition of the medical knowledge gene condition 16 were carried out for convenience by the discrimination formula optimizing part 8. Such optimization operations may be executed by the discrimination formula generating part 7 or the like. Alternatively, the drug effect-adverse effect prediction system 1 can be provided, as it were, with an element for optimization of the discrimination formula, and this element for optimization can carry out the optimization operations. Moreover, these names of the optimizing part are not limiting. Furthermore, although an example was explained of deletion of the redundant gene condition constituting the discrimination formula and then deleting or adding the medical knowledge condition 16, the execution of these procedures does not need to be in this order. These procedures can be executed in the reverse order. Also, the medical knowledge condition 16 deletion or addition can be executed selectively (as an option).

During generation of the discrimination formula by the below described optimization of combinations, numerous gene conditions having low redundancy can be combined, and it is possible to generate a discrimination formula that has high reliability and a low number of gene conditions.

Based on the use of the discrimination formula optimizing part 8 and the medical knowledge condition 16 for selection of conditions having high clinical reliability prior to the optimization, it is possible to incorporate into the discrimination formula a corresponding low number of high clinical-reliability conditions. On the other hand, if there are conditions of high share rate but low clinical reliability in the clinical data 10, then removal is possible at a stage prior to combination optimization.

For example, if a gene condition taken to be effective for the clinical data 10 contained in the database 3 is determined to actually have low medical reliability, such a gene condition should not be used in the discrimination formula. On the other hand, if the clinical data for a certain genotype combination is statistically scant, and if this genotype has a high rate of an adverse effect when patients have this genotype combination, it is possible that this genotype combination may not be incorporated in the discrimination formula due to the low clinical data count corresponding to this gene condition during the selection of genotype combinations as effective gene conditions. This type of gene condition can be considered for use in the discrimination formula without considering combinations of gene conditions. Such data relating to a gene condition can be included beforehand in the medical knowledge conditions 16.

Then, during the generation of the discrimination formula by combination optimization of the gene conditions of step S7, the selected effective gene conditions are combined, and a discrimination formula is designed which has a designated reliability of at least R % (>r). If combination optimization processing is not needed at this time, then it is also possible to combine all gene conditions having a designated reliability of at least R % to produce the discrimination formula. Reliability may increase due to combination optimization in comparison to the non-optimized case. Although the number of gene conditions used in the discrimination formula may decrease, due to combination optimization, the correct number of classifications (corresponding number) or the share rate for the clinical data of the clinical data database decreases. This combination optimization of gene conditions is executed by the discrimination formula optimizing part 8.

The method for design of the discrimination formula having a reliability of at least R % by the combination optimization of step S7 will next be explained.

The discrimination formula is designed by combination based on OR logic calculation of conditions where the share rate is at least R % for the classification label. Due to the combination of conditions having an share rate is at least R % for the classification label (referred to hereinafter as the “candidate condition”), a large number of clinical data correspond to the discrimination formula, and combinations are searched for which the share rate becomes high for the classification label. During combination searching, gene condition combinations (discrimination formulae) are evaluated based firstly on the number of corresponding clinical data and secondly on the share rate for the classification label. Combinations are searched using a feature selection algorithm SFFS (Sequential Forward Floating Search).

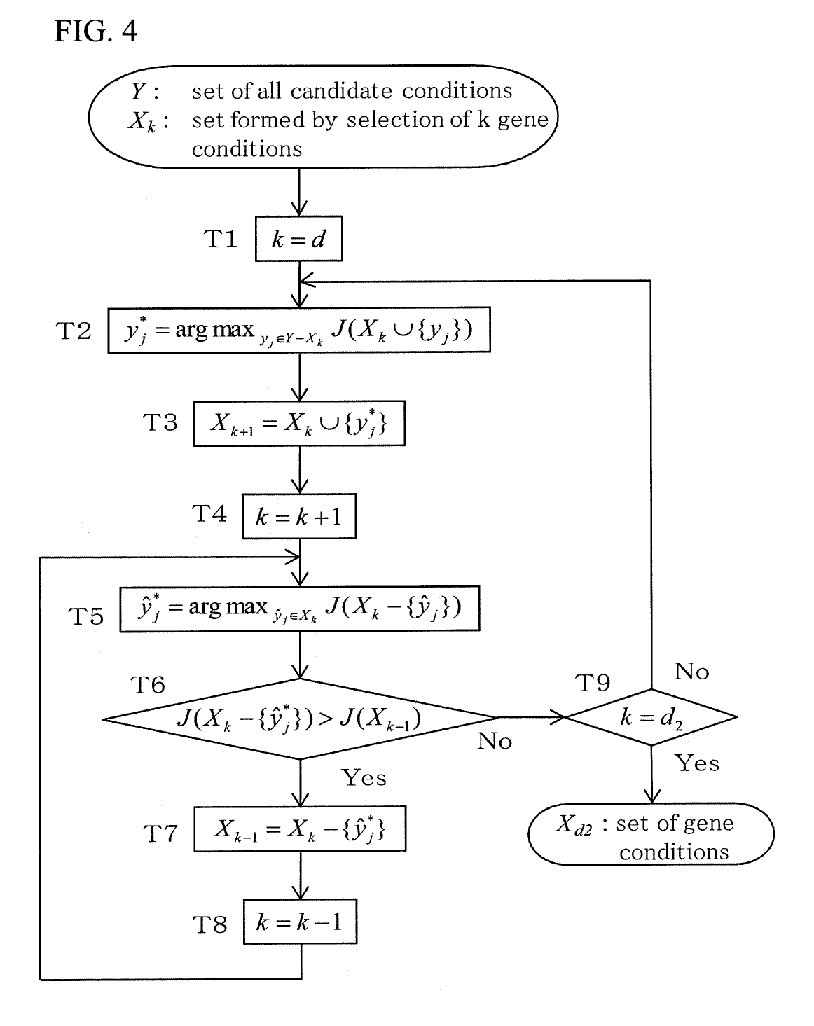

FIG. 4 shows the procedure for combination optimization executed by the discrimination formula optimizing part of the drug effect-adverse effect prediction system of the present embodiment. This combination optimization procedure is indicated as step 7 within FIG. 3. Within FIG. 4, Y indicates the set of all candidate gene conditions. Xₖ indicates a set of (k) gene conditions, and (d) indicates an initial gene condition count. J indicates a discrimination formula evaluation function, and d₂ indicates the number of combinations at the end of optimization.

Firstly, if (d) gene conditions are selected using the discrimination formula using the introduction of medical knowledge conditions 16 and the discrimination formula optimizing part 8, (d) combinations are taken to be the initial combinations; but if the utilized gene conditions are not selected, then the initial combinations are taken to be the empty set (d=0) (step T1). Thereafter, within the gene conditions not included in the gene condition set Xₖ selected previously from the total candidate gene condition set Y, a gene condition yⱼ* is searched for that maximizes performance of the discrimination formula (gene condition set Xₖ) due to appending to the gene condition set Xₖ (step T2). The gene condition yⱼ*selected during step T2 is appended to the discrimination formula (gene condition set Xₖ) (step T3), and the variable (k) indicating the selected gene condition count is increased by 1 (step T4).

Specifically, although appending of the candidate condition is executed by the discrimination formula optimizing part 8, when a new discrimination formula is made using the combination of (k+1) gene conditions generated by appending one candidate condition to the combination of (k) previously selected gene conditions, among the candidate conditions having a maximum clinical data count (relevant number) of the classification label corresponding to the new discrimination formula, the candidate condition is searched for that has the maximum share rate for the classification label (step T2). This candidate condition is then appended to the combination of (k) gene conditions (step T3), and a new discrimination formula is generated from the combination of (k+1) gene conditions (step T4).

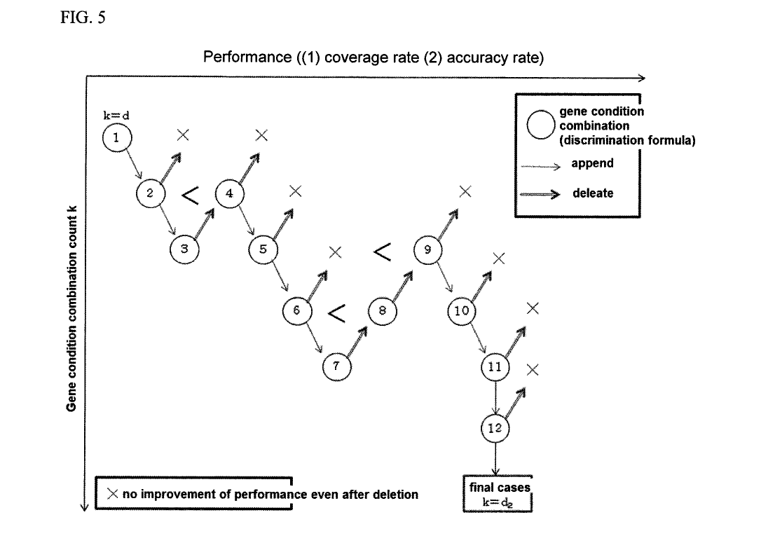

The expression “performance of the discrimination formula” in the present application, as indicated in FIG. 5, firstly means the relevant number (correct classification count) and secondly means the share rate. Here, “firstly” and “secondly” refer to the order of precedence. The discrimination formula optimizing part 8, as mentioned above, firstly searches for the gene condition that maximizes the relevant number of the classification labels, and thereafter, secondly searches the candidate conditions for the candidate condition that maximizes the share rate of the classification label.

This procedure emphasizes a certain degree of general versatility rather than simply emphasizing reliability (accuracy) of the discrimination formula. Therefore, if improvement of reliability is a goal even at the expense of general versatility, the order of precedence for performance may be reversed.

After appending of the gene condition by the discrimination formula optimizing part 8, the same discrimination formula optimizing part 8 is used for searching to find if a discrimination formula exists for improvement of performance of the discrimination formula by deletion of a gene condition from among the combinations.

Among the previously selected gene condition set Xₖ, a gene condition ŷⱼ* is searched for that maximizes performance of the discrimination formula by deletion from the gene condition set Xₖ (step T5). Relative to the earlier discrimination formula based on (k−1) gene conditions (gene condition set Xₖ₋₁), a determination is made (step T6) as to whether or not performance is surpassed by removal of the gene condition ŷⱼ* selected during this step T5. If performance was found to improve, then execution proceeds to step T7. If performance was not found to improve, execution proceeds to step T9.

The gene condition is executed by the discrimination formula optimizing part 8, and specifically, from among discrimination formula candidates taken to be the (k−1) gene candidate combinations generated by removal of 1 deletion candidate condition from among the previously selected (k) gene candidates, a deletion candidate condition is searched for (step T5) that maximizes the share rate for the classification label and that maximizes the clinical data count of classification labels corresponding to the discrimination formula candidate. Based on the discrimination formula resulting from the previous (k−1) gene condition combinations, if the clinical data count for the corresponding classification label increases for the discrimination formula candidate after such deletion, or if the clinical data count of the corresponding classification label is the same, a determination is made as to whether the share rate for the classification label increases (step T6). If the determination is made that there is an increase, then the deletion candidate condition is deleted from the combination, and the gene condition combination is updated as the (k−1) gene condition combination (step T7). If the determination was not that there was such an increase, then execution proceeds to step T9.

Although the object of step T6 was a comparison with the discrimination formula formed from (k−1) gene conditions, due to incrementing of (k) by 1 during step T4, (k) becomes equal to (k+1), and this incremented value becomes that same as the k up to step 3.

During step T7, the gene condition ŷⱼ* selected during step T5 is deleted from the gene condition set Xₖ. During step T8, the variable (k) indicating the number of selected gene conditions is decremented by 1.

During step T9, a determination is made as to whether or not the gene condition combination count (k) has reached a designated threshold value d₂. If the gene condition combination count (k) has reached the designated threshold value d₂, then the optimization ends.

Otherwise, execution proceeds to step T2.

In this manner during step S7 as shown in FIG. 3, due to repeated appending or deletion of candidate conditions with respect to the initial combination (k=d), the combination of gene conditions used in the discrimination formula is optimized. When a gene condition has been deleted, there is the possibility of generating a discrimination formula that has higher performance due to further deletion of gene conditions. Thus, deletion of gene conditions is repeatedly performed by the discrimination formula optimizing part 8. When gene condition deletion has not been performed, gene condition appending is performed by the discrimination formula optimizing part 8.

During deletion of the gene condition, by separate arrangement so that determination is made depending on whether the candidate for deletion is a medical knowledge condition 16 included in a combination resulting from introduction beforehand of the medical knowledge condition, it is possible to designate whether to allow the possibility of deletion by the discrimination formula optimizing part 8 of a medical knowledge condition 16 during the optimization process.

After appropriately repeated appending and deletion by the discrimination formula optimizing part 8, when the gene condition combination count reaches the designated threshold value d₂, the combination optimization ends (step T9). This threshold value may be input from the exterior during execution of the optimization process. Alternatively, data relating to the threshold value or a data table relating to multiple threshold values may be stored beforehand in the database 3, and during execution of the optimization process, such data may be read out, or alternatively, the data table may be displayed by the display device, and selection may be made possible using the discrimination formula optimizing part 8.

Finally, among the discrimination formulae at each of the combination counts, among the discrimination formula having the maximum share rate for the classification label and having the maximum clinical data count of the corresponding classification label, the discrimination formula is finally chosen that has the minimum combination of gene conditions. This type of determining requirement of the discrimination formula can be stored beforehand in the database 3 or can be contained in the discrimination formula optimizing part 8.

Although appending and deletion of the gene condition is executed by the discrimination formula optimizing part 8 in the present embodiment, appending and deletion, for example, can, of course, be executed separately by an independently arranged first discrimination formula optimizing part and second discrimination formula optimizing part, respectively.

FIG. 5 shows an example of the shifts of performance of optimized combination of gene conditions due to combination optimization of gene conditions executed using the discrimination formula optimizing part of the drug effect-adverse effect prediction system 1 of the present embodiment.

Firstly, a model (combination) selecting (d) gene conditions based on medical knowledge is indicated by circle 1 of FIG. 5. One gene condition is appended to shift to the combination of circle 2 so that combined performance becomes highest relative to this combination of these d gene conditions. Here, as shown in FIG. 5, the performance means a high clinical data count corresponding to the combination of these gene conditions (e.g., excellent general versatility) and also means a high share rate of the entire clinical data count (clinical data count of the classification label) corresponding to these gene condition combinations.

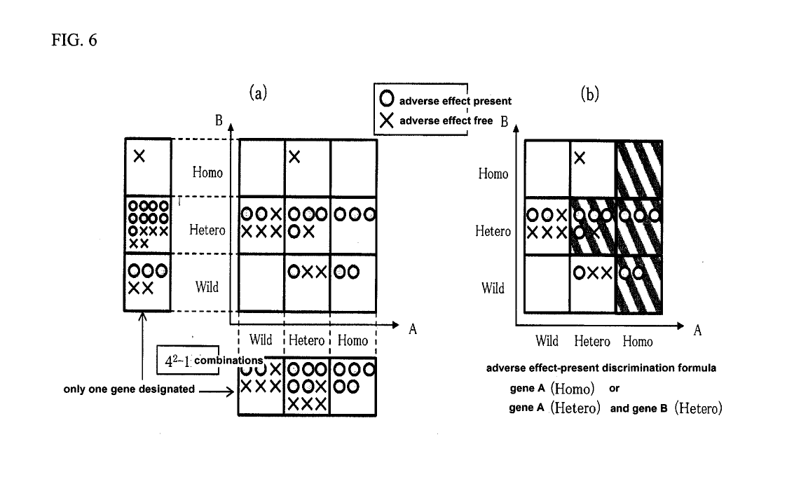

For the circle 2 combination, because the performance does not improve even when a single gene condition is deleted, deletion is not performed, and one gene condition is further appended, and there is a shift to the circle 3 combination. Within FIG. 5, the absence of a high performance “condition combination” is indicated by the X symbol. Removal of one gene condition from the circle 3 combination improves performance over that of the circle 2 combination, so one gene combination is deleted to shift to the circle 4 combination. When the gene condition is deleted, although the circle 4, where the combination count of gene conditions in the discrimination formula is the same, is certain to have higher performance than circle 2, the difference in the combination count of the gene conditions (e.g., between circle 3 and circle 4) is not a problem. Thus, there may be instances in which circle 4 performance is higher than that of circle 3, and there may instances in which circle 4 performance is lower than that of circle 3. In FIG. 6, for example, circle 4 is shown to the upper right of circle 3, and the difference in performance between circle 2 and circle 4 is indicated by the inequality sign.

Because performance is not improved for this circle 4 even if a further gene condition is deleted, one gene condition is appended, and processing shifts to the combination of circle 5. Upon further repetition of appending and deletion, at the circle 11, performance does not improve, whatever the gene condition that is appended. In this situation, addition to the combination is carried out giving precedence a high share rate for the classification label for the appended gene condition by itself. In a situation where the performance does not improved even after appending a gene condition, performance sometimes improves due to deletion of a gene condition that was appended at a stage near the start due to successive appending of gene conditions. Thus appending and deletion are repeated until the gene condition combination count conforms to the previously set final condition of k=d₂. In this example, performance is highest and the combination count is lowest for the circle 11 combination, and this is adopted for the discrimination formula.

Generation of a discrimination formula for the classification “adverse effect present” of a drug will be explained next using two genotypes and using the example shown in FIG. 6. In FIG. 6(a) is a schematic drawing of the drug effect-adverse effect prediction system of the present embodiment reacting to the presence or absence of clinical data of adverse effects and genotype combinations considering A and B as two genotypes (Homo, Hetero, and Wild). FIG. 6(b) is a conceptual drawing showing the condition for generation of gene conditions as the discrimination formula for the presence of an adverse effect as an share rate greater than or equal to 70%.

According to the example shown in FIG. 6, the total number of combinations (gene conditions) of genotypes for the discrimination formula becomes (3+1)²−1=15. Here 20 cases of clinical data 10 are used for generation of the discrimination formula. Within FIG. 6, clinical data that had an adverse effect are indicated by “O”, and clinical data that had no adverse effect are indicated by “x”. The reliability analysis part 6 of the drug effect-adverse effect prediction system 1 firstly examines the corresponding clinical data for “adverse effect-present” and “adverse effect-free” as the various classification labels, and the reliability analysis part 6 calculates the share rate for “adverse effect-free.” The corresponding clinical data counts and share rates of each gene condition are shown in Table 1. Here, an entry of “−” in the column indicating the gene type (genotype) means that the genotype is not specified.

Next, the discrimination formula generating part 7 selects as effective gene conditions those gene conditions that have a relevant number n greater than or equal to 1 and a share rate r greater than or equal to 70% for the presence of an adverse effect. The selected useful gene conditions are indicated by the circle symbol in Table 1 or are indicated by hatching in FIG. 6(b).

Here, the introduction of the medical knowledge condition 16 by the discrimination formula optimizing part 8 is omitted. Combination optimization is performed by the discrimination formula optimizing part 8 for the 4 gene conditions selected as effective gene conditions, and the 70% or greater reliability adverse effect-free discrimination formula is generated.

Firstly, from the gene conditions extracted by the discrimination formula generating part 7, the discrimination formula optimizing part 8 selects a gene condition 1 (gene A (Homo)) as the first gene condition. Next, the discrimination formula optimizing part 8 combines there gene conditions and adds to the discrimination formula the gene condition 11 (gene A (Hetero) and gene B (Hetero)) resulting in the maximum correct classification count. The gene condition appending and deletion (by the discrimination formula optimizing part 8) are repeated further according to algorithm, and although addition up to a combination count of 4 is possible, since in this example the discrimination formula using the gene condition 1 and the gene condition 11 combination has the highest performance, further explanation will be omitted below.

Therefore, the discrimination formula (at least 70% reliability) for the presence of an adverse effect that was generated from the gene A form and the gene B form becomes equal to the expression ((gene A (Homo)) OR (gene A (Hetero) AND gene B (Hetero))).

When the presence of an adverse effect is predicted (at least 70% reliability) by the discrimination formula generated for the 20 clinical data examples used in the present example, the prediction is for an adverse effect being present in 10 cases out of 20.

There is actually an adverse effect present in 9 cases among 10 classified for the presence of an adverse effect, and an adverse effect did not occur in one case.

TABLE 1

| Gene | | | Corresponding case count | | | Effective |
|---|---|---|---|---|---|---|
| condition | Condition | | has adverse | adverse effect- | Share rate for cases | conditions |
| no. | Gene A | Gene B | effect | free | having an adverse effect | n ≧ 1, r ≧ 70 |
| 1 | Homo | — | 5 | 0 | 100% | ◯ |
| 2 | Hetero | — | 5 | 4 | 56% | |
| 3 | Wild | — | 2 | 4 | 33% | |
| 4 | — | Homo | 0 | 1 | 0% | |
| 5 | — | Hetero | 9 | 5 | 64% | |
| 6 | — | Wild | 3 | 2 | 60% | |
| 7 | Homo | Homo | 0 | 0 | — | |
| 8 | Homo | Hetero | 3 | 0 | 100% | ◯ |
| 9 | Homo | Wild | 2 | 0 | 100% | ◯ |
| 10 | Hetero | Homo | 0 | 1 | 0% | |
| 11 | Hetero | Hetero | 4 | 1 | 80% | ◯ |
| 12 | Hetero | Wild | 1 | 2 | 33% | |
| 13 | Wild | Homo | 0 | 0 | — | |
| 14 | Wild | Hetero | 2 | 4 | 33% | |
| 15 | Wild | Wild | 0 | 0 | — | |

The prediction part 4 of the drug effect-adverse effect prediction system 1 of the present embodiment uses the discrimination formula data 12 constructed by the discrimination formula design part 2 to perform prediction of an effect-adverse effect for the patient 15 who is the subject of prediction of an effect-adverse effect.

For the classification labels A and B (e.g., adverse effect-present and adverse effect-free), multiple discrimination formulae (hereinafter, the term “discrimination formulae” is sometimes taken to have the same meaning as the discrimination formula data 12) are generated by changing the degree of reliability. By performance of predictions by multiple uses of discrimination formulae having different degrees of reliability, it becomes possible to make a prediction for an individual the patient 15 with high general versatility and an assigned degree of reliability.

When the degrees of reliability are taken to be R₁, R₂, . . . Rₘ₁ (R₁>R₂> . . . >Rₘ₁) and R₁, R₂, . . . Rₘ₂ (R₁>R₂> . . . >Rₘ₂), the discrimination formula A (R₁), discrimination formula A (R₂), . . . discrimination formula A (Rₘ₁), discrimination formula B (R₁), discrimination formula B (R₁), . . . discrimination formula B (Rₘ₂) are used.

For example, a discrimination formula (here the term “discrimination formula” has the same meaning even when the gene conditions are replaced) having 100% reliability but a low corresponding clinical data count among the clinical data 10 of the database 3 is considered to have comparatively low general versatility due to the low corresponding clinical data count. However, due to obtaining a classification result 13 having high reliability in for this discrimination formula, this is an effective discrimination formula for diagnosis with a high degree of confidence.

On the other hand, a 70% reliability discrimination formula having a comparatively high corresponding clinical data count among the clinical data 10 of the database 3, upon comparison with a 100% reliability discrimination formula, has a low confidence level but is effective as a discrimination formula for diagnosis with high general versatility. In the present application, multiple discrimination formulae are used for predicting. The result of the check of whether these correspond to gene conditions for the respective discrimination formula is termed the “classification result” 13, and among such results a result termed the “prediction result” 14 is used for determination for the patient 15.

Data of the combinations of genes and genotypes relating to the patient 15, who is the subject of the prediction, are examined to determine whether there is correspondence to a discrimination formula in order of reliability for the classification A and classification B. When the patient corresponds to a gene condition of a discrimination formula, this discrimination formula level of confidence is taken to be the level of confidence of the classification result 13. At this time, if there is correspondence only in either the classification A or classification B, that classification result 13 is used. When there is correspondence in the discrimination formula of both classification A and classification B, the classification result 13 having a higher level of confidence is adopted. Moreover, when there is correspondence for both classification A and classification B, and if the corresponding discrimination formula levels of confidence are equal, or alternatively if there is no correspondence for any of the discrimination formulae of both classification A and classification B, then the determination is withheld.

For example, when predicting the presence or absence of an adverse effect, the “adverse effect-present” discrimination formula is designed for levels of confidence of 100%, 80% or greater, and 70% or greater. The “adverse effect-free” discrimination formula is designed for levels of confidence of 100%, 80% or greater, and 70% or greater. When the patient C corresponds to an “adverse effect-present” discrimination formula (level of confidence of at least 80%), and when the patient C does not correspond to any of the discrimination formulae for “adverse effect-free,” then the prediction for the patient C becomes “There will be an adverse effect at a confidence level of at least 80%.” If the patient D corresponds to the adverse effect-present discrimination formula (level of confidence of at least 70%) and to the “adverse effect-free” discrimination formula (level of confidence of at least 80%), the prediction for the patient D becomes “There will be no adverse effect at a confidence level of 80%.” If the patient E corresponds to the adverse effect-present discrimination formula (level of confidence of at least 70%) and to the “adverse effect-free” discrimination formula (level of confidence of at least 70%), the prediction for the patient E becomes “Determination is withheld.” If the patient F corresponds to the neither the “adverse effect-present” nor “adverse effect-free” discrimination formulae, then the prediction for the patient F becomes “Determination is withheld.”

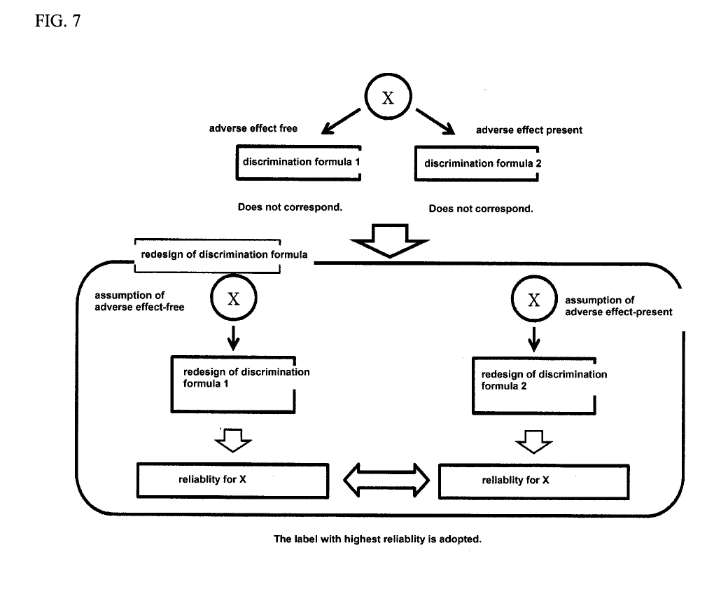

For a patient X, who has had a withheld determination, as shown in FIG. 7, it is possible to hypothesize one of the classification labels, to enter a hypothetical record in the clinical data database, and to redesign the discrimination formula of the hypothesized classification label so as to make possible estimation of the level of confidence for the hypothesized classification level. FIG. 7 is a conceptual drawing showing the method of estimation of the level of confidence when the determination has been withheld using the drug effect-adverse effect prediction system of the present embodiment. This function can be realized by the prediction part 4 using jointly the clinical data analysis table generating part 5, the reliability analysis part 6, and the discrimination formula generating part 7.

For example, during predicting of the presence or absence of an adverse effect, the patient X is hypothesized to be “adverse effect-present.” When the discrimination formula is redesigned for “adverse effect-present,” the share rate in the discrimination formula imparting the highest share rate classified as “adverse effect-present” is used as the level of confidence that patient X is “adverse effect-present.”

Specifically, when the prediction part 4 has determined that the determination is withheld, this fact is displayed by the display device or the like, and simultaneously, a display is shown prompting for a determination of whether to make an estimate and prompting for the selection of one of the classification labels for carrying out further estimation, e.g., “effective,” “ineffective,” “adverse effect present,” or “adverse effect free.” When the selection of this display has been made, according to the classification label display, the clinical data analysis table generating part 5 appends data of this patient to the analysis table 11 as clinical data 10 for this classification label. The clinical data analysis table generating part 5 contains this analysis table 11 in a form that can be read out to the database 3.

Thereafter, the reliability analysis part 6 reads the analysis table 11 and calculates the share rate, and the discrimination formula generating part 7 generates the discrimination formulae in the same manner as for the previously explained extracted gene conditions. Among the discrimination formulae generated in this manner, the prediction part 4 estimates the level of confidence for one of the below listed 2 cases:

(1) while the corresponding clinical data count is greater than or equal to (p) (p is greater than 1), a gene condition imparts the maximum share rate (this gene condition is considered as an independent “discrimination formula”);

(2) a discrimination formula generated by a gene condition that has a share rate of at least (r) and a corresponding clinical data count of at least (p).

The share rate of the gene condition of (1), or the overall share rate for the discrimination formula of (2), is selected as the level of confidence corresponding to that classification of that patient, and this estimate result is output to the display device or the like as the prediction result.

The result calculated by the reliability analysis part 6 is reflected in the analysis table 11 and is stored in a readable form in the database 3, and also the discrimination formula generated by the discrimination formula generating part 7 is stored in a readable form in the database 3 as the discrimination formula data 12. The discrimination formula selected by the prediction part 4 and the share rate of the discrimination formula are stored in a readable form in the database 3.

However, when an “adverse effect-free” discrimination formula is redesigned for a patient X hypothesized to be “adverse effect-free,” the share rate for the discrimination formula imparting the maximum share rate classified as “adverse effect-free” for the patient is set as the level of confidence that the patient X is “adverse effect-free.” At this time, the level of confidence of “adverse effect-present” for the patient and the level of confidence of “adverse effect-free” are compared, and by classification of the patient X using the higher of the levels of confidence, it is possible to make a prediction for a patient who does not correspond to any of the discrimination formulae. Furthermore, when the level of confidence during classification is low, it is possible to make a determination of “determination withheld” without classifying. The threshold value for the level of confidence used at this time may be stored beforehand in the database 3, may be obtained by prompting for input during the display prompting for a decision as to whether to make an estimate after a withholding of determination, or may be stored as a set value in the prediction part 4 itself.

Although the present embodiment was explained as a system, the system shown in FIG. 1 is treated as general purpose computer, and the program for operation of the computer is considered to execute the procedure of the flowchart shown in FIG. 3. Taking this into account, per the above explanation, while the various steps are executed by the computer, the discrimination formula data 12 from the analysis table 11 are generated, and an embodiment was explained for the program that outputs the prediction result relating to the presence or absence of the drug effect-adverse effect. The operation and effect of this program are the same operation and effect for an embodiment of the previously explained drug effect-adverse effect prediction system.

### Example 1

The prediction of effects-adverse effects when administering the anti-cancer drug irinotecan is indicated below as Example 1.

Clinical data from 71 cases of the administration of irinotecan were used, and discrimination formulae were designed for prediction of effects-adverse effects according to the form of 6 genes forms, e.g., UGT1A1*28, UGT1A1*6, UGT1A9*22, UGT1A7-N129K, UGT1A1*60, and UGT1A7-57T/G.

Because the subject genes each had three forms (e.g., Homo, Hetero, and Wild), the total combination count becomes ((3+1)⁶−1)=4,095.

Labels for adverse effects were assigned using evaluations for neutrophil cell decrease or leucocyte decrease as grades 0-2 (adverse effect free) or grades 3-4 (adverse effect present). Labels for effectiveness were assigned using evaluations for colon cancer shrinkage effect as CR/PR (effective) or as SD/PD (ineffective). Among the 71 cases, 37 cases (52.1%) were “adverse effect-free,” and 34 cases (47.9%) were “adverse effect-present.” Also, 23 cases (33.3%) were “effective,” and 46 cases (66.6%) were “ineffective,” while the remaining 2 cases were “unable to evaluate.” For the prediction of adverse effects, discrimination formulae were generated by setting the levels of confidence at 100%, at least 80%, and at least 70% for both “adverse effect-free” and “adverse effect-present.” For the prediction of effectiveness, discrimination formulae were generated by setting the levels of confidence at 100% and at least 80% for “effective,” and setting the levels of confidence at 100%, at least 80%, at least 70%, and at least 50% for “ineffective.” Table 2 through Table 8 show an example of listings of effective gene conditions and an example of results of optimization. The prediction results for the 73 cases is shown in Table 9.

How to read the tables will be explained using Table 2 as an example. Table 2 shows the effective gene conditions for prediction of the “effective” label for effective use of irinotecan, and this table also shows the combination optimization results for these effective gene conditions. The first line of the table shows the gene conditions having at least a 70% share rate of “effective,” the relevant numbers among the 71 cases (CR/PR=effective, SD/PD=ineffective, and totals for these labels), and the share rates (CR/PR=effective, SD/PD=ineffective). From left to right, the six gene conditions are UGT1A1*28, UGT1A1*6, UGT1A9*22, UGT1A7-N129K, UGT1A1*60, and UGT1A7-57T/G, and these are indicated as being Wild, Hetero, Homo, or blank (not determined). For example, for the 1st gene condition, UGT1A1*6 is indicated as G/A, and UGT1A9*22 is indicated as T10/10. The CR/PR relevant number for this gene condition is 1 case, and the SD/PD relevant number for this gene condition is 0 cases. The share rates are indicated as 100% (CR/PR) and 0.0% (SD/PD). For the 24th gene condition, UGT1A7N129 is shown as G/G, UGT1A1*60 is shown as T/G, and UGT1A7-57T/G is shown as T/G. The CR/PR relevant number for this gene condition is 3 cases, and the SD/PD relevant number for this gene condition is 1 case. The share rates are indicated as 75.0% (CR/PR) and 25.0% (SD/PD). When these results are combined by OR logic calculation of the 24 formulae, the CR/PR relevant number is 7 cases, and the SD/PD relevant number is 1 case. The share rates are indicated to be 87.5% (CR/PR) and 12.5% (SD/PD). The 24 formulae were optimized for at least 70%, at least 80%, and 100% share rates. For the optimization at the 70% or greater level, 4 gene conditions are selected, according to this discrimination formula the CR/PR relevant number is 7 cases, the SD/PD relevant number is 1 case, and the share rates are shown as 87.5% (CR/PR) and 12.5% (SD/PD). For the optimization at the 80% or greater level, 4 gene conditions are selected, according to this discrimination formula the CR/PR relevant number is 7 cases, the SD/PD relevant number is 1 case, and the share rates are shown as 87.5% (CR/PR) and 12.5% (SD/PD). For the optimization at the 100% level, 5 gene conditions are selected, according to this discrimination formula the CR/PR relevant number is 5 cases, the SD/PD relevant number is 0 cases, and the share rates are shown as 100.0% (CR/PR) and 0.0% (SD/PD).

TABLE 2

| | UGT1A1*28 | UGT1A1*6 | UGT1A9*22 | UGT1A7 | UGT1A1*60 | UGT1A7 | Case count | | | Share rate | |
|---|---|---|---|---|---|---|---|---|---|---|---|
| | −53(TA) | 211G/A | −118T | N129K | −3279 T/G | −57 T/G | CR/PR | SD/PD | total | CR/PR | SD/PD |
| effective | | | | | | | | | | | |
| | | G/A | T10/10 | | | | 1 | 0 | 1 | 100.0% | 0.0% |
| | | | T10/10 | T/G | | | 1 | 0 | 1 | 100.0% | 0.0% |
| | | | T10/10 | | | T/G | 1 | 0 | 1 | 100.0% | 0.0% |
| | TA6/TA7 | G/A | T9/9 | | | | 1 | 0 | 1 | 100.0% | 0.0% |
| | TA6/TA7 | G/A | | G/G | | | 1 | 0 | 1 | 100.0% | 0.0% |
| | TA6/TA6 | | T10/10 | | T/G | | 1 | 0 | 1 | 100.0% | 0.0% |
| | TA6/TA6 | | | T/T | T/G | | 1 | 0 | 1 | 100.0% | 0.0% |
| | TA6/TA6 | | | | T/G | G/G | 1 | 0 | 1 | 100.0% | 0.0% |
| | | G/A | | | T/G | G/G | 1 | 0 | 1 | 100.0% | 0.0% |
| | TA6/TA6 | G/G | | | T/G | T/G | 1 | 0 | 1 | 100.0% | 0.0% |
| | TA6/TA6 | | T9/10 | | T/G | T/G | 1 | 0 | 1 | 100.0% | 0.0% |
| | TA6/TA7 | | T9/9 | | T/G | T/G | 1 | 0 | 1 | 100.0% | 0.0% |
| | TA6/TA6 | | | T/G | T/G | T/G | 1 | 0 | 1 | 100.0% | 0.0% |
| | TA6/TA7 | | | G/G | T/G | T/G | 1 | 0 | 1 | 100.0% | 0.0% |
| | | G/A | T9/9 | | T/G | | 4 | 1 | 5 | 80.0% | 20.0% |
| | | G/A | | G/G | T/G | | 4 | 1 | 5 | 80.0% | 20.0% |
| | TA6/TA6 | G/A | | | T/G | | 3 | 1 | 4 | 75.0% | 25.0% |
| | TA6/TA6 | | T9/9 | | T/G | | 3 | 1 | 4 | 75.0% | 25.0% |
| | TA6/TA6 | | | G/G | T/G | | 3 | 1 | 4 | 75.0% | 25.0% |
| | TA6/TA6 | | | | T/G | T/G | 3 | 1 | 4 | 75.0% | 25.0% |
| | | G/A | T9/9 | | | T/G | 3 | 1 | 4 | 75.0% | 25.0% |
| | | G/A | | G/G | | T/G | 3 | 1 | 4 | 75.0% | 25.0% |
| | | | T9/9 | | T/G | T/G | 3 | 1 | 4 | 75.0% | 25.0% |
| | | | | G/G | T/G | T/G | 3 | 1 | 4 | 75.0% | 25.0% |
| 24 formulae total | | | | | | | 7 | 1 | 8 | 87.5% | 12.5% |
| optimization at level of at least 70% | | | | | | | | | | | |
| | | G/A | T9/9 | | T/G | | 4 | 1 | 5 | 80.0% | 20.0% |
| | | G/A | T10/10 | | | | 1 | 0 | 1 | 100.0% | 0.0% |
| | TA6/TA6 | | T10/10 | | T/G | | 1 | 0 | 1 | 100.0% | 0.0% |
| | TA6/TA6 | | | | T/G | T/G | 3 | 1 | 4 | 75.0% | 25.0% |
| 4 formulae total | | | | | | | 7 | 1 | 8 | 87.5% | 12.5% |
| optimization at level of at least 80% | | | | | | | | | | | |
| | | G/A | T9/9 | | T/G | | 4 | 1 | 5 | 80.0% | 20.0% |
| | | G/A | T10/10 | | | | 1 | 0 | 1 | 100.0% | 0.0% |
| | TA6/TA6 | | T10/10 | | T/G | | 1 | 0 | 1 | 100.0% | 0.0% |
| | TA6/TA6 | G/G | | | T/G | T/G | 1 | 0 | 1 | 100.0% | 0.0% |
| 4 formulae total | | | | | | | 7 | 1 | 8 | 87.5% | 12.5% |
| optimiztion at level of at least 100% | | | | | | | | | | | |
| | | G/A | T10/10 | | | | 1 | 0 | 1 | 100.0% | 0.0% |
| | TA6/TA7 | G/A | T9/9 | | | | 1 | 0 | 1 | 100.0% | 0.0% |
| | TA6/TA6 | | T10/10 | | T/G | | 1 | 0 | 1 | 100.0% | 0.0% |
| | TA6/TA6 | | | | T/G | G/G | 1 | 0 | 1 | 100.0% | 0.0% |
| | TA6/TA6 | G/G | | | T/G | T/G | 1 | 0 | 1 | 100.0% | 0.0% |

| | | | | | |
|---|---|---|---|---|---|
| 5 formulae total | 5 | 0 | 5 | 100.0% | 0.0% |

TABLE 3

| | UGT1A1*28 | UGT1A1*6 | UGT1A9*22 | UGT1A7 | UGT1A1*60 | UGT1A7 | Case count | | | Share rate | |
|---|---|---|---|---|---|---|---|---|---|---|---|
| ineffective | −53(TA) | 211G/A | −118T | N129K | −3279 T/G | −57 T/G | CR/PR | SD/PD | total | CR/PR | SD/PD |
| | TA6/TA7 | | T9/10 | | | | 0 | 6 | 6 | 0.0% | 100.0% |
| | TA6/TA7 | | | T/G | | | 0 | 6 | 6 | 0.0% | 100.0% |
| | TA6/TA7 | | T9/10 | | T/G | | 0 | 5 | 5 | 0.0% | 100.0% |
| | TA6/TA7 | | T9/10 | | | T/G | 0 | 5 | 5 | 0.0% | 100.0% |
| | TA6/TA7 | | | T/G | T/G | | 0 | 5 | 5 | 0.0% | 100.0% |
| | TA6/TA7 | | | T/G | | T/G | 0 | 5 | 5 | 0.0% | 100.0% |
| | | | | | G/G | | 0 | 4 | 4 | 0.0% | 100.0% |
| | | G/G | T9/9 | | | | 0 | 4 | 4 | 0.0% | 100.0% |
| | | G/G | | G/G | | | 0 | 4 | 4 | 0.0% | 100.0% |
| | TA6/TA7 | G/G | T9/10 | | | | 0 | 4 | 4 | 0.0% | 100.0% |
| | TA6/TA7 | G/G | | T/G | | | 0 | 4 | 4 | 0.0% | 100.0% |
| | TA6/TA7 | G/G | | | | T/G | 0 | 4 | 4 | 0.0% | 100.0% |
| | TA6/TA7 | | | | G/G | | 0 | 3 | 3 | 0.0% | 100.0% |
| | | | T9/9 | | G/G | | 0 | 3 | 3 | 0.0% | 100.0% |
| | | | | G/G | G/G | | 0 | 3 | 3 | 0.0% | 100.0% |
| | | | | | G/G | T/T | 0 | 3 | 3 | 0.0% | 100.0% |
| | TA6/TA7 | G/G | T9/9 | | | | 0 | 3 | 3 | 0.0% | 100.0% |
| | TA6/TA7 | G/G | | G/G | | | 0 | 3 | 3 | 0.0% | 100.0% |
| | TA6/TA7 | G/G | T9/10 | | T/G | | 0 | 3 | 3 | 0.0% | 100.0% |
| | TA6/TA7 | G/G | T9/10 | | | T/G | 0 | 3 | 3 | 0.0% | 100.0% |
| | TA6/TA7 | G/G | | T/G | T/G | | 0 | 3 | 3 | 0.0% | 100.0% |
| | TA6/TA7 | G/G | | T/G | | T/G | 0 | 3 | 3 | 0.0% | 100.0% |
| | TA6/TA7 | G/G | | | T/G | T/G | 0 | 3 | 3 | 0.0% | 100.0% |
| | | | T9/9 | | | T/T | 0 | 2 | 2 | 0.0% | 100.0% |
| | | | | G/G | | T/T | 0 | 2 | 2 | 0.0% | 100.0% |

TABLE 4

| | UGT1A1*28 | UGT1A1*6 | UGT1A9*22 | UGT1A7 | UGT1A1*60 | UGT1A7 | Case count | | | Share rate | |
|---|---|---|---|---|---|---|---|---|---|---|---|
| | −53(TA) | 211G/A | −118T | N129K | −3279 T/G | −57 T/G | CR/PR | SD/PD | total | CR/PR | SD/PD |
| ineffective (cont.) | | | | | | | | | | | |
| | TA6/TA7 | | | | | T/G | 1 | 6 | 7 | 14.3% | 85.7% |
| | TA6/TA7 | G/G | | | T/G | | 1 | 6 | 7 | 14.3% | 85.7% |
| | TA6/TA7 | | | | | | 2 | 11 | 13 | 16.4% | 84.6% |
| | | G/G | | | | T/G | 1 | 5 | 6 | 16.7% | 83.3% |
| | TA6/TA7 | | | | T/G | T/G | 1 | 5 | 6 | 16.7% | 83.3% |
| | | | T9/10 | | T/G | T/G | 1 | 5 | 6 | 16.7% | 83.3% |
| | | | | T/G | T/G | T/G | 1 | 5 | 6 | 16.7% | 83.3% |
| | TA6/TA7 | | | | T/G | | 2 | 8 | 10 | 20.0% | 80.0% |
| | TA6/TA7 | | | | | T/T | 1 | 4 | 5 | 20.0% | 80.0% |
| | | G/G | T9/10 | | | T/G | 1 | 4 | 5 | 20.0% | 80.0% |
| | | G/G | | T/G | | T/G | 1 | 4 | 5 | 20.0% | 80.0% |
| 70 formulae total | | | | | | | 3 | 15 | 18 | 16.7% | 83.3% |
| optimization at level of at least 80% | | | | | | | | | | | |
| | | G/G | T9/10 | | T/T | | 0 | 2 | 2 | 0.0% | 100.0% |
| | | | | | G/G | | 0 | 4 | 4 | 0.0% | 100.0% |
| | | G/A | T9/9 | | T/T | | 0 | 1 | 1 | 0.0% | 100.0% |
| | TA6/TA7 | G/G | | | | | 1 | 9 | 10 | 10.0% | 90.0% |
| | TA6/TA7 | | T9/10 | | | | 0 | 6 | 6 | 0.0% | 100.0% |
| 5 formulae total | | | | | | | 1 | 15 | 16 | 6.3% | 93.8% |
| optimiztion at level of at least 100% | | | | | | | | | | | |
| | TA6/TA7 | | T9/10 | | | | 0 | 6 | 6 | 0.0% | 100.0% |
| | | G/G | T9/9 | | | | 0 | 4 | 4 | 0.0% | 100.0% |
| | | G/G | T9/10 | | T/T | | 0 | 2 | 2 | 0.0% | 100.0% |
| | | G/A | T9/9 | | T/T | | 0 | 1 | 1 | 0.0% | 100.0% |

| | | | | | |
|---|---|---|---|---|---|
| 4 formulae total | 0 | 13 | 13 | 0.0% | 100.0% |

TABLE 5

| | UGT1A1*28 | UGT1A1*6 | UGT1A9*22 | UGT1A7 | UGT1A1*60 | UGT1A7 | Case count | | | Share rate | |
|---|---|---|---|---|---|---|---|---|---|---|---|
| adverse effect free | −53(TA) | 211G/A | −118T | N129K | −3279 T/G | −57 T/G | G0-2 | G3.4 | total | G0-2 | G3.4 |
| | | G/A | | | | G/G | 2 | 0 | 2 | 100.0% | 0.0% |
| | | | | | T/G | G/G | 2 | 0 | 2 | 100.0% | 0.0% |
| | TA6/TA7 | | | | G/G | T/T | 2 | 0 | 2 | 100.0% | 0.0% |
| | | G/G | T9/10 | | T/T | | 2 | 0 | 2 | 100.0% | 0.0% |
| | | G/G | | T/G | T/T | | 2 | 0 | 2 | 100.0% | 0.0% |
| | TA6/TA7 | | | | | G/G | 1 | 0 | 1 | 100.0% | 0.0% |
| | | G/A | T10/10 | | | | 1 | 0 | 1 | 100.0% | 0.0% |
| | | G/G | | | | G/G | 1 | 0 | 1 | 100.0% | 0.0% |
| | | | T10/10 | T/G | | | 1 | 0 | 1 | 100.0% | 0.0% |
| | | | T9/10 | | G/G | | 1 | 0 | 1 | 100.0% | 0.0% |
| | | | T10/10 | | | T/G | 1 | 0 | 1 | 100.0% | 0.0% |
| | | | | T/G | G/G | | 1 | 0 | 1 | 100.0% | 0.0% |
| | TA6/TA7 | | T9/10 | | | T/T | 1 | 0 | 1 | 100.0% | 0.0% |
| | TA6/TA7 | | T9/9 | | | T/T | 1 | 0 | 1 | 100.0% | 0.0% |
| | TA6/TA7 | | | T/G | | T/T | 1 | 0 | 1 | 100.0% | 0.0% |
| | TA6/TA7 | | | G/G | | T/T | 1 | 0 | 1 | 100.0% | 0.0% |
| | TA6/TA6 | | | | T/G | G/G | 1 | 0 | 1 | 100.0% | 0.0% |
| | | G/G | T9/9 | | T/G | | 1 | 0 | 1 | 100.0% | 0.0% |
| | | G/A | T9/9 | | T/T | | 1 | 0 | 1 | 100.0% | 0.0% |
| | | G/G | | G/G | T/G | | 1 | 0 | 1 | 100.0% | 0.0% |
| | | G/A | | G/G | T/T | | 1 | 0 | 1 | 100.0% | 0.0% |
| | | G/G | | | T/T | T/G | 1 | 0 | 1 | 100.0% | 0.0% |
| | | G/A | | | T/T | G/G | 1 | 0 | 1 | 100.0% | 0.0% |
| | | G/A | | | T/G | G/G | 1 | 0 | 1 | 100.0% | 0.0% |
| | | | T9/10 | | T/T | T/T | 1 | 0 | 1 | 100.0% | 0.0% |
| | | | | T/G | T/T | T/T | 1 | 0 | 1 | 100.0% | 0.0% |
| | TA6/TA7 | | | | | T/T | 4 | 1 | 5 | 80.0% | 20.0% |
| | | G/G | | | T/T | | 17 | 5 | 22 | 77.3% | 22.7% |
| | | | T10/10 | | T/T | | 16 | 5 | 21 | 76.2% | 23.8% |
| | | | | | T/T | T/T | 16 | 5 | 21 | 76.2% | 23.8% |
| | | | | T/T | T/T | | 16 | 6 | 20 | 75.0% | 25.0% |
| | | G/G | T10/10 | | T/T | | 15 | 5 | 20 | 75.0% | 25.0% |
| | | | T10/10 | | T/T | T/T | 15 | 5 | 20 | 75.0% | 25.0% |
| | TA6/TA6 | | T10/10 | | | | 17 | 5 | 23 | 73.9% | 26.1% |
| | | | T10/10 | | | | 19 | 7 | 26 | 73.1% | 26.9% |
| | TA6/TA6 | | | T/T | | | 16 | 6 | 22 | 72.7% | 27.3% |
| | TA6/TA6 | G/G | T10/10 | | | | 16 | 6 | 22 | 72.7% | 27.3% |
| | TA6/TA6 | | T10/10 | | | T/T | 16 | 6 | 22 | 72.7% | 27.3% |
| | | | | T/T | | | 18 | 7 | 25 | 72.0% | 28.0% |
| | | G/G | T10/10 | | | | 18 | 7 | 25 | 72.0% | 28.0% |
| | | | T10/10 | | | T/T | 18 | 7 | 25 | 72.0% | 28.0% |

| | | | | | |
|---|---|---|---|---|---|
| 41 formulae total | 26 | 7 | 33 | 78.8% | 21.2% |

TABLE 6

| | UGT1A1*28 | UGT1A1*6 | UGT1A9*22 | UGT1A7 | UGT1A1*60 | UGT1A7 | Case count | | | Share rate | |
|---|---|---|---|---|---|---|---|---|---|---|---|
| | −53(TA) | 211G/A | −118T | N129K | −3279 T/G | −57 T/G | G0-2 | G3.4 | total | G0-2 | G3.4 |
| adverse effect free | | | | | | | | | | | |
| optimization at level of at least 70% | | | | | | | | | | | |
| | TA6/TA7 | | | | | T/T | 4 | 1 | 5 | 80.0% | 20.0% |
| | | G/G | | | T/T | | 17 | 5 | 22 | 77.3% | 22.7% |
| | | G/A | | | | G/G | 2 | 0 | 2 | 100.0% | 0.0% |
| | TA6/TA6 | | T10/10 | | | | 17 | 6 | 23 | 73.9% | 26.1% |
| | TA6/TA7 | | | | | G/G | 1 | 0 | 1 | 100.0% | 0.0% |
| 5 formulae total | | | | | | | 26 | 7 | 33 | 78.8% | 21.2% |
| optimization at level of at least 80% | | | | | | | | | | | |
| | TA6/TA7 | | | | | T/T | 4 | 1 | 5 | 80.0% | 20.0% |
| | | G/A | | | | G/G | 2 | 0 | 2 | 100.0% | 0.0% |
| | | G/G | T9/10 | | T/T | | 2 | 0 | 2 | 100.0% | 0.0% |
| | TA6/TA7 | | | | | G/G | 1 | 0 | 1 | 100.0% | 0.0% |
| | | G/A | T10/10 | | | | 1 | 0 | 1 | 100.0% | 0.0% |
| 5 formulae total | | | | | | | 10 | 1 | 11 | 90.9% | 9.1% |
| optimiztion at level of at least 100% | | | | | | | | | | | |
| | | G/A | | | | G/G | 2 | 0 | 2 | 100.0% | 0.0% |
| | TA6/TA7 | | | | G/G | T/T | 2 | 0 | 2 | 100.0% | 0.0% |
| | | G/G | T9/10 | | T/T | | 2 | 0 | 2 | 100.0% | 0.0% |
| | TA6/TA7 | | | | | G/G | 1 | 0 | 1 | 100.0% | 0.0% |
| | | G/A | T10/10 | | | | 1 | 0 | 1 | 100.0% | 0.0% |

| | | | | | |
|---|---|---|---|---|---|
| 5 formulae total | 8 | 0 | 8 | 100.0% | 0.0% |

TABLE 7

| | UGT1A1*28 | UGT1A1*6 | UGT1A9*22 | UGT1A7 | UGT1A1*60 | UGT1A7 | Case count | | | Share rate | |
|---|---|---|---|---|---|---|---|---|---|---|---|
| adverse effect present | −53(TA) | 211G/A | −118T | N129K | −3279 T/G | −57 T/G | G0-2 | G3.4 | total | G0-2 | G3.4 |
| | TA6/TA7 | G/A | | | | | 0 | 3 | 3 | 0.0% | 100.0% |
| | | A/A | | | | | 0 | 2 | 2 | 0.0% | 100.0% |
| | TA6/TA7 | G/A | T9/10 | | | | 0 | 2 | 2 | 0.0% | 100.0% |
| | TA6/TA7 | G/A | | T/G | | | 0 | 2 | 2 | 0.0% | 100.0% |
| | TA6/TA7 | | T9/9 | | | T/G | 0 | 2 | 2 | 0.0% | 100.0% |
| | TA6/TA7 | | | G/G | | T/G | 0 | 2 | 2 | 0.0% | 100.0% |
| | | G/A | T9/10 | | T/G | | 0 | 2 | 2 | 0.0% | 100.0% |
| | | G/A | | T/G | T/G | | 0 | 2 | 2 | 0.0% | 100.0% |
| | TA6/TA6 | | | | G/G | | 0 | 1 | 1 | 0.0% | 100.0% |
| | | | | | G/G | T/G | 0 | 1 | 1 | 0.0% | 100.0% |
| | TA6/TA6 | G/G | T9/9 | | | | 0 | 1 | 1 | 0.0% | 100.0% |
| | TA6/TA7 | G/A | T9/9 | | | | 0 | 1 | 1 | 0.0% | 100.0% |
| | TA6/TA6 | G/G | | G/G | | | 0 | 1 | 1 | 0.0% | 100.0% |
| | TA6/TA7 | G/A | | G/G | | | 0 | 1 | 1 | 0.0% | 100.0% |
| | TA6/TA6 | | T9/9 | | | T/T | 0 | 1 | 1 | 0.0% | 100.0% |
| | TA6/TA6 | | | G/G | | T/T | 0 | 1 | 1 | 0.0% | 100.0% |
| | | G/G | T9/9 | | | T/G | 0 | 1 | 1 | 0.0% | 100.0% |
| | | G/G | | G/G | | T/G | 0 | 1 | 1 | 0.0% | 100.0% |
| | TA6/TA6 | G/G | | | T/G | T/G | 0 | 1 | 1 | 0.0% | 100.0% |
| | TA6/TA6 | | T9/10 | | T/G | T/G | 0 | 1 | 1 | 0.0% | 100.0% |
| | TA6/TA7 | | T9/9 | | T/G | T/G | 0 | 1 | 1 | 0.0% | 100.0% |
| | TA6/TA6 | | | T/G | T/G | T/G | 0 | 1 | 1 | 0.0% | 100.0% |
| | TA6/TA7 | | | G/G | T/G | T/G | 0 | 1 | 1 | 0.0% | 100.0% |
| | | G/A | | | T/G | T/G | 1 | 5 | 6 | 16.7% | 83.3% |
| | | | T9/9 | | | T/G | 1 | 4 | 5 | 20.0% | 80.0% |
| | | | | G/G | | T/G | 1 | 4 | 5 | 20.0% | 80.0% |
| | TA6/TA7 | | | | | T/G | 2 | 6 | 8 | 25.0% | 75.0% |
| | TA6/TA6 | | | | T/G | T/G | 1 | 3 | 4 | 25.0% | 75.0% |
| | | G/A | T9/9 | | | T/G | 1 | 3 | 4 | 25.0% | 75.0% |
| | | G/A | | G/G | | T/G | 1 | 3 | 4 | 25.0% | 75.0% |
| | | | T9/9 | | T/G | T/G | 1 | 3 | 4 | 25.0% | 75.0% |
| | | | | G/G | T/G | T/G | 1 | 3 | 4 | 25.0% | 75.0% |
| | | | | | T/G | T/G | 3 | 8 | 11 | 27.3% | 72.7% |
| | | G/A | | | T/G | | 2 | 5 | 7 | 28.6% | 71.4% |
| | TA6/TA7 | | | | T/G | T/G | 2 | 5 | 7 | 28.6% | 71.4% |
| | | | T9/10 | | T/G | T/G | 2 | 5 | 7 | 28.6% | 71.4% |
| | | | | T/G | T/G | T/G | 2 | 5 | 7 | 28.6% | 71.4% |

| | | | | | |
|---|---|---|---|---|---|
| 37 formulae total | 4 | 12 | 16 | 25.0% | 75.0% |

TABLE 8

| | UGT1A1*28 | UGT1A1*6 | UGT1A9*22 | UGT1A7 | UGT1A1*60 | UGT1A7 | Case count | | | Share rate | |
|---|---|---|---|---|---|---|---|---|---|---|---|
| | −53(TA) | 211G/A | −118T | N129K | −3279 T/G | −57 T/G | G0-2 | G3.4 | total | G0-2 | G3.4 |
| adverse effect present | | | | | | | | | | | |
| optimization at level of at least 70% | | | | | | | | | | | |
| | | | | | T/G | T/G | 3 | 8 | 11 | 27.3% | 72.7% |
| | | A/A | | | | | 0 | 2 | 2 | 0.0% | 100.0% |
| | TA6/TA6 | | | | G/G | | 0 | 1 | 1 | 0.0% | 100.0% |
| | TA6/TA7 | | | | | T/G | 2 | 6 | 8 | 25.0% | 75.0% |
| 4 formulae total | | | | | | | 3 | 12 | 15 | 20.0% | 80.0% |
| optimization at level of at least 80% | | | | | | | | | | | |
| | | G/A | | | T/G | T/G | 1 | 5 | 6 | 16.7% | 83.3% |
| | | A/A | | | | | 0 | 2 | 2 | 0.0% | 100.0% |
| | TA6/TA6 | | | | G/G | | 0 | 1 | 1 | 0.0% | 100.0% |
| | | | T9/9 | | | T/G | 1 | 4 | 5 | 20.0% | 80.0% |
| | TA6/TA6 | G/G | | | T/G | T/G | 0 | 1 | 1 | 0.0% | 100.0% |
| 5 formulae total | | | | | | | 1 | 10 | 11 | 9.1% | 90.9% |
| optimiztion at level of at least 100% | | | | | | | | | | | |
| | TA6/TA7 | G/A | | | | | 0 | 3 | 3 | 0.0% | 100.0% |
| | | A/A | | | | | 0 | 2 | 2 | 0.0% | 100.0% |
| | TA6/TA6 | | | | G/G | | 0 | 1 | 1 | 0.0% | 100.0% |
| | | | | | G/G | T/G | 0 | 1 | 1 | 0.0% | 100.0% |
| | TA6/TA6 | G/G | | | T/G | T/G | 0 | 1 | 1 | 0.0% | 100.0% |

| | | | | | |
|---|---|---|---|---|---|
| 5 formulae total | 0 | 8 | 8 | 0.0% | 100.0% |

TABLE 9

| | | Case | Share | Confidence | | |
|---|---|---|---|---|---|---|
| | | count | rate | 100% | 100% | 100% |
| effectiveness | effective | 24 | 33.8% | 5 - 0 | 7 - 1 | 7 - 1 |
| | ineffective | 47 | 66.2% | 13 - 0 | 15 - 1 | — |
| adverse | adverse effect | 39 | 53.4% | 8 - 0 | 10 - 1 | 26 - 7 |
| effect | free | | | | | |
| | adverse effect | 34 | 46.6% | 8 - 0 | 10 - 1 | 12 - 3 |
| | present | | | | | |

(correct classification count - error classification count)

### Example 2

The prediction of effects-adverse effects when administering the anti-cancer drug irinotecan using the 1st line and 2nd line in the 6 genes of Example 1 is shown next as Example 2. The clinical data, classification method, and the like are the same as those of Example 1. Respective discrimination formulae were generated separately for the clinical data of the 1st line and the 2nd line. Table 10 through Table 16 show a listing of the effective gene conditions using the first line and show an example of results of optimization. Table 17 through Table 23 show a listing of the effective gene conditions using the second line and show an example of results of optimization. Table 24 shows predictions for the 73 cases.

TABLE 10

| 1st line | UGT1A1*28 | UGT1A1*6 | UGT1A9*22 | UGT1A7 | UGT1A1*60 | UGT1A7 | Case count | | | Share rate | |
|---|---|---|---|---|---|---|---|---|---|---|---|
| effective | −53(TA) | 211G/A | −118T | N129K | −3279 T/G | −57 T/G | CR/PR | SD/PD | total | CR/PR | SD/PD |
| | | G/A | T9/9 | | | | 4 | 0 | 4 | 100.0% | 0.0% |
| | | G/A | | G/G | | | 4 | 0 | 4 | 100.0% | 0.0% |
| | | | T9/9 | | T/G | | 4 | 0 | 4 | 100.0% | 0.0% |
| | | | | G/G | T/G | | 4 | 0 | 4 | 100.0% | 0.0% |
| | TA6/TA6 | G/A | T9/9 | | | | 3 | 0 | 3 | 100.0% | 0.0% |
| | TA6/TA6 | G/A | | G/G | | | 3 | 0 | 3 | 100.0% | 0.0% |
| | TA6/TA6 | G/A | | | T/G | | 3 | 0 | 3 | 100.0% | 0.0% |
| | TA6/TA6 | | T9/9 | | T/G | | 3 | 0 | 3 | 100.0% | 0.0% |
| | TA6/TA6 | | | G/G | T/G | | 3 | 0 | 3 | 100.0% | 0.0% |
| | TA6/TA6 | | | | T/G | T/G | 3 | 0 | 3 | 100.0% | 0.0% |
| | | G/A | T9/9 | | | T/G | 3 | 0 | 3 | 100.0% | 0.0% |
| | | G/A | | G/G | | T/G | 3 | 0 | 3 | 100.0% | 0.0% |
| | | | T9/9 | | T/G | T/G | 3 | 0 | 3 | 100.0% | 0.0% |
| | | | | G/G | T/G | T/G | 3 | 0 | 3 | 100.0% | 0.0% |
| | | | T10/10 | | T/G | | 2 | 0 | 2 | 100.0% | 0.0% |
| | | | | T/T | T/G | | 2 | 0 | 2 | 100.0% | 0.0% |
| | TA6/TA6 | | T9/9 | | | T/G | 2 | 0 | 2 | 100.0% | 0.0% |
| | TA6/TA6 | | | G/G | | T/G | 2 | 0 | 2 | 100.0% | 0.0% |
| | TA6/TA6 | G/A | | | T/G | T/G | 2 | 0 | 2 | 100.0% | 0.0% |
| | TA6/TA7 | | T10/10 | | | | 1 | 0 | 1 | 100.0% | 0.0% |
| | TA6/TA7 | | | T/T | | | 1 | 0 | 1 | 100.0% | 0.0% |
| | TA6/TA7 | | | | | T/T | 1 | 0 | 1 | 100.0% | 0.0% |
| | | G/A | T10/10 | | | | 1 | 0 | 1 | 100.0% | 0.0% |
| | | G/A | | | | G/G | 1 | 0 | 1 | 100.0% | 0.0% |
| | | | T10/10 | T/G | | | 1 | 0 | 1 | 100.0% | 0.0% |
| | | | T10/10 | | | T/G | 1 | 0 | 1 | 100.0% | 0.0% |
| | | | | | T/G | G/G | 1 | 0 | 1 | 100.0% | 0.0% |
| | TA6/TA7 | G/A | T9/9 | | | | 1 | 0 | 1 | 100.0% | 0.0% |
| | TA6/TA7 | G/A | | G/G | | | 1 | 0 | 1 | 100.0% | 0.0% |
| | TA6/TA6 | G/G | | | | T/G | 1 | 0 | 1 | 100.0% | 0.0% |
| | TA6/TA6 | | T10/10 | | T/G | | 1 | 0 | 1 | 100.0% | 0.0% |
| | TA6/TA7 | | T9/9 | | T/G | | 1 | 0 | 1 | 100.0% | 0.0% |
| | TA6/TA6 | | | T/T | T/G | | 1 | 0 | 1 | 100.0% | 0.0% |
| | TA6/TA7 | | | G/G | T/G | | 1 | 0 | 1 | 100.0% | 0.0% |
| | TA6/TA6 | | T9/10 | | T/G | T/G | 1 | 0 | 1 | 100.0% | 0.0% |
| | TA6/TA6 | | | T/G | T/G | T/G | 1 | 0 | 1 | 100.0% | 0.0% |
| | | G/A | | | T/G | | 4 | 1 | 5 | 80.0% | 20.0% |
| | | | T9/9 | | | T/G | 3 | 1 | 4 | 75.0% | 25.0% |
| | | | | G/G | | T/G | 3 | 1 | 4 | 75.0% | 25.0% |
| | | G/A | | | T/G | T/G | 3 | 1 | 4 | 75.0% | 25.0% |
| | TA6/TA6 | | | | T/G | | 8 | 3 | 11 | 72.7% | 27.3% |

| | | | | | |
|---|---|---|---|---|---|
| 41 formulae total | 11 | 6 | 16 | 68.8% | 31.3% |

TABLE 11

| | UGT1A1*28 | UGT1A1*6 | UGT1A9*22 | UGT1A7 | UGT1A1*60 | UGT1A7 | Case count | | | Share rate | |
|---|---|---|---|---|---|---|---|---|---|---|---|
| 1st line | −53(TA) | 211G/A | −118T | N129K | −3279 T/G | −57 T/G | CR/PR | SD/PD | total | CR/PR | SD/PD |
| effective | | | | | | | | | | | |
| optimization at level of at least 70% | | | | | | | | | | | |
| | | TA6/TA6 | | | | T/G | 8 | 3 | 11 | 72.7% | 27.3% |
| | | TA6/TA7 | | T10/10 | | | 1 | 0 | 1 | 100.0% | 0.0% |
| | | | G/A | T10/10 | | | 1 | 0 | 1 | 100.0% | 0.0% |
| | | | G/A | T9/9 | | | 4 | 0 | 4 | 100.0% | 0.0% |
| 4 formulae total | | | | | | | 11 | 3 | 14 | 78.6% | 21.4% |
| optimization at level of at least 80% | | | | | | | | | | | |
| | | G/A | T9/9 | | | | 4 | 0 | 4 | 100.0% | 0.0% |
| | | | T10/10 | | T/G | | 2 | 0 | 2 | 100.0% | 0.0% |
| | | G/A | T10/10 | | | | 1 | 0 | 1 | 100.0% | 0.0% |
| | TA6/TA6 | G/G | | | | T/G | 1 | 0 | 1 | 100.0% | 0.0% |
| 4 formulae total | | | | | | | 8 | 0 | 8 | 100.0 | 0.0% |
| optimiztion at level of at least 100% | | | | | | | | | | | |
| | | G/A | T9/9 | | | | 4 | 0 | 4 | 100.0% | 0.0% |
| | | | T10/10 | | T/G | | 2 | 0 | 2 | 100.0% | 0.0% |
| | | G/A | T10/10 | | | | 1 | 0 | 1 | 100.0% | 0.0% |
| | TA6/TA6 | G/G | | | | T/G | 1 | 0 | 1 | 100.0% | 0.0% |

| | | | | | |
|---|---|---|---|---|---|
| 4 formulae total | 8 | 0 | 8 | 100.0% | 0.0% |

TABLE 12

| 1st line | UGT1A1*28 | UGT1A1*6 | UGT1A9*22 | UGT1A7 | UGT1A1*60 | UGT1A7 | Case count | | | Share rate | |
|---|---|---|---|---|---|---|---|---|---|---|---|
| ineffective | −53(TA) | 211G/A | −118T | N129K | −3279 T/G | −57 T/G | CR/PR | SD/PD | total | CR/PR | SD/PD |
| | | | | | G/G | | 0 | 2 | 2 | 0.0% | 100.0% |
| | TA6/TA7 | | T9/10 | | | | 0 | 2 | 2 | 0.0% | 100.0% |
| | TA6/TA7 | | | T/G | | | 0 | 2 | 2 | 0.0% | 100.0% |
| | | G/G | T9/9 | | | | 0 | 2 | 2 | 0.0% | 100.0% |
| | | G/G | | G/G | | | 0 | 2 | 2 | 0.0% | 100.0% |
| | TA6/TA7 | G/G | | | | T/G | 0 | 2 | 2 | 0.0% | 100.0% |
| | | A/A | | | | | 0 | 1 | 1 | 0.0% | 100.0% |
| | TA6/TA6 | | | | G/G | | 0 | 1 | 1 | 0.0% | 100.0% |
| | TA6/TA7 | | | | G/G | | 0 | 1 | 1 | 0.0% | 100.0% |
| | | | T9/9 | | T/T | | 0 | 1 | 1 | 0.0% | 100.0% |
| | | | T9/9 | | | T/T | 0 | 1 | 1 | 0.0% | 100.0% |
| | | | | G/G | T/T | | 0 | 1 | 1 | 0.0% | 100.0% |
| | | | | G/G | | T/T | 0 | 1 | 1 | 0.0% | 100.0% |
| | | | | | T/T | G/G | 0 | 1 | 1 | 0.0% | 100.0% |
| | | | | | G/G | T/T | 0 | 1 | 1 | 0.0% | 100.0% |
| | | | | | G/G | T/G | 0 | 1 | 1 | 0.0% | 100.0% |
| | TA6/TA6 | G/G | T9/9 | | | | 0 | 1 | 1 | 0.0% | 100.0% |
| | TA6/TA7 | G/G | T9/10 | | | | 0 | 1 | 1 | 0.0% | 100.0% |
| | TA6/TA7 | G/G | T9/9 | | | | 0 | 1 | 1 | 0.0% | 100.0% |
| | TA6/TA7 | G/A | T9/10 | | | | 0 | 1 | 1 | 0.0% | 100.0% |
| | TA6/TA6 | G/G | | G/G | | | 0 | 1 | 1 | 0.0% | 100.0% |
| | TA6/TA7 | G/G | | T/G | | | 0 | 1 | 1 | 0.0% | 100.0% |
| | TA6/TA7 | G/G | | G/G | | | 0 | 1 | 1 | 0.0% | 100.0% |
| | TA6/TA7 | G/A | | T/G | | | 0 | 1 | 1 | 0.0% | 100.0% |
| | | G/G | T9/10 | | T/T | | 0 | 1 | 1 | 0.0% | 100.0% |
| | | G/A | T9/10 | | T/G | | 0 | 1 | 1 | 0.0% | 100.0% |
| | | G/G | T9/9 | | | T/G | 0 | 1 | 1 | 0.0% | 100.0% |
| | | G/G | | T/G | T/T | | 0 | 1 | 1 | 0.0% | 100.0% |
| | | G/A | | T/G | T/G | | 0 | 1 | 1 | 0.0% | 100.0% |
| | | G/G | | G/G | | T/G | 0 | 1 | 1 | 0.0% | 100.0% |
| | | | T9/10 | | T/T | T/T | 0 | 1 | 1 | 0.0% | 100.0% |
| | | | | T/G | T/T | T/T | 0 | 1 | 1 | 0.0% | 100.0% |
| | TA6/TA7 | G/G | | | T/G | T/G | 0 | 1 | 1 | 0.0% | 100.0% |
| | TA6/TA7 | | | | | T/G | 1 | 3 | 4 | 25.0% | 75.0% |
| | | G/A | T9/10 | | | | 2 | 5 | 7 | 28.6% | 71.4% |
| | | | T9/10 | | T/T | | 2 | 5 | 7 | 28.6% | 71.4% |

| | | | | | |
|---|---|---|---|---|---|
| 36 formulae total | 3 | 10 | 13 | 23.1% | 76.9% |

TABLE 13

| | UGT1A1*28 | UGT1A1*6 | UGT1A9*22 | UGT1A7 | UGT1A1*60 | UGT1A7 | Case count | | | Share rate | |
|---|---|---|---|---|---|---|---|---|---|---|---|
| 1st line | −53(TA) | 211G/A | −118T | N129K | −3279 T/G | −57 T/G | CR/PR | SD/PD | total | CR/PR | SD/PD |
| ineffective | | | | | | | | | | | |
| optimization at level of at least 70% | | | | | | | | | | | |
| | | | | | G/G | | 0 | 2 | 2 | 0.0% | 100.0% |
| | TA6/TA7 | | T9/10 | | | | 0 | 2 | 2 | 0.0% | 100.0% |
| | | | T9/10 | | T/T | | 2 | 5 | 7 | 28.6% | 71.4% |
| | | | T9/9 | | T/T | | 0 | 1 | 1 | 0.0% | 100.0% |
| 4 formulae total | | | | | | | 2 | 10 | 12 | 16.7% | 83.3% |
| optimization at level of at least 80% | | | | | | | | | | | |
| | | | | | G/G | | 0 | 2 | 2 | 0.0% | 100.0% |
| | TA6/TA7 | | T9/10 | | | | 0 | 2 | 2 | 0.0% | 100.0% |
| | | A/A | | | | | 0 | 1 | 1 | 0.0% | 100.0% |
| | | G/G | T9/10 | | T/T | | 0 | 1 | 1 | 0.0% | 100.0% |
| 4 formulae total | | | | | | | 0 | 6 | 6 | 0.0% | 100.0% |
| optimiztion at level of at least 100% | | | | | | | | | | | |
| | | | | | G/G | | 0 | 2 | 2 | 0.0% | 100.0% |
| | TA6/TA7 | | T9/10 | | | | 0 | 2 | 2 | 0.0% | 100.0% |
| | | A/A | | | | | 0 | 1 | 1 | 0.0% | 100.0% |
| | | G/G | T9/10 | | T/T | | 0 | 1 | 1 | 0.0% | 100.0% |

| | | | | | |
|---|---|---|---|---|---|
| 4 formulae total | 0 | 6 | 6 | 0.0% | 100.0% |

TABLE 14

| | UGT1A1*28 | UGT1A1*6 | UGT1A9*22 | UGT1A7 | UGT1A1*60 | UGT1A7 | Case count | | | Share rate | |
|---|---|---|---|---|---|---|---|---|---|---|---|
| 1st line | −53(TA) | 211G/A | −118T | N129K | −3279 T/G | −57 T/G | G0-2 | G3.4 | total | G0-2 | G3.4 |
| adverse effect free | | | | | | | | | | | |
| | TA6/TA7 | | T10/10 | | | | 1 | 0 | 1 | 100.0% | 0.0% |
| | TA6/TA7 | | | T/T | | | 1 | 0 | 1 | 100.0% | 0.0% |
| | TA6/TA7 | | | | | T/T | 1 | 0 | 1 | 100.0% | 0.0% |
| | | G/A | T10/10 | | | | 1 | 0 | 1 | 100.0% | 0.0% |
| | | G/A | | | | G/G | 1 | 0 | 1 | 100.0% | 0.0% |
| | | | T10/10 | T/G | | | 1 | 0 | 1 | 100.0% | 0.0% |
| | | | T10/10 | | | T/G | 1 | 0 | 1 | 100.0% | 0.0% |
| | | | | | T/G | G/G | 1 | 0 | 1 | 100.0% | 0.0% |
| | | G/G | T9/10 | | T/T | | 1 | 0 | 1 | 100.0% | 0.0% |
| | | G/G | | T/G | T/T | | 1 | 0 | 1 | 100.0% | 0.0% |
| | | | T9/10 | | T/T | T/T | 1 | 0 | 1 | 100.0% | 0.0% |
| | | | | T/G | T/T | T/T | 1 | 0 | 1 | 100.0% | 0.0% |
| | | G/G | | | T/T | | 8 | 3 | 11 | 72.7% | 27.3% |
| | | | T10/10 | | T/T | | 8 | 3 | 11 | 72.7% | 27.3% |
| | | | | | T/T | T/T | 8 | 3 | 11 | 72.7% | 27.3% |
| | | | T10/10 | | | | 10 | 4 | 14 | 71.41% | 28.6% |
| | | | T9/10 | | | T/T | 5 | 2 | 7 | 71.41% | 28.6% |
| | | | | T/G | | T/T | 5 | 2 | 7 | 71.41% | 28.6% |
| | | | | T/T | T/T | | 7 | 3 | 10 | 70.0% | 30.0% |
| | | G/G | T10/10 | | T/T | | 7 | 3 | 10 | 70.0% | 30.0% |
| | | | T10/10 | | T/T | T/T | 7 | 3 | 10 | 70.0% | 30.0% |
| 21 formulae total | | | | | | | 16 | 6 | 22 | 72.7% | 27.3% |
| optimization at level of at least 70% | | | | | | | | | | | |
| | | | T10/10 | | | | 10 | 4 | 14 | 71.4% | 28.6% |
| | | | T9/10 | | | T/T | 5 | 2 | 7 | 71.4% | 28.6% |
| | | G/A | | | | G/G | 1 | 0 | 1 | 100.0% | 0.0% |
| 3 formulae total | | | | | | | 16 | 6 | 22 | 72.7% | 27.3% |
| optimization at level of at least 80% | | | | | | | | | | | |
| | TA6/TA7 | | T10/10 | | | | 1 | 0 | 1 | 100.0% | 0.0% |
| | | G/A | T10/10 | | | | 1 | 0 | 1 | 100.0% | 0.0% |
| | | G/A | | | | G/G | 1 | 0 | 1 | 100.0% | 0.0% |
| | | G/G | T9/10 | | T/T | | 1 | 0 | 1 | 100.0% | 0.0% |
| 24 formulae total | | | | | | | 4 | 0 | 4 | 100.0% | 0.0% |
| optimiztion at level of at least 100% | | | | | | | | | | | |
| | TA6/TA7 | | T10/10 | | | | 1 | 0 | 1 | 100.0% | 0.0% |
| | | G/A | T10/10 | | | | 1 | 0 | 1 | 100.0% | 0.0% |
| | | G/A | | | | G/G | 1 | 0 | 1 | 100.0% | 0.0% |
| | | G/G | T9/10 | | T/T | | 1 | 0 | 1 | 100.0% | 0.0% |

| | | | | | |
|---|---|---|---|---|---|
| 4 formulae total | 4 | 0 | 4 | 100.0% | 0.0% |

TABLE 15

| 1st line | UGT1A1*28 | UGT1A1*6 | UGT1A9*22 | UGT1A7 | UGT1A1*60 | UGT1A7 | Case count | | | Share rate | |
|---|---|---|---|---|---|---|---|---|---|---|---|
| adverse effect present | −53(TA) | 211G/A | −118T | N129K | −3279 T/G | −57 T/G | G0-2 | G3.4 | total | G0-2 | G3.4 |
| | | | T9/9 | | | T/G | 0 | 4 | 4 | 0.0% | 100.0% |
| | | | | G/G | | T/G | 0 | 4 | 4 | 0.0% | 100.0% |
| | | G/A | | | T/G | T/G | 0 | 4 | 4 | 0.0% | 100.0% |
| | TA6/TA6 | | | | T/G | T/G | 0 | 3 | 3 | 0.0% | 100.0% |
| | | G/A | T9/9 | | | T/G | 0 | 3 | 3 | 0.0% | 100.0% |
| | | G/A | | G/G | | T/G | 0 | 3 | 3 | 0.0% | 100.0% |
| | | | T9/9 | | T/G | T/G | 0 | 3 | 3 | 0.0% | 100.0% |
| | | | | G/G | T/G | T/G | 0 | 3 | 3 | 0.0% | 100.0% |
| | | | | | G/G | | 0 | 2 | 2 | 0.0% | 100.0% |
| | TA6/TA7 | G/A | | | | | 0 | 2 | 2 | 0.0% | 100.0% |
| | TA6/TA7 | | T9/9 | | | | 0 | 2 | 2 | 0.0% | 100.0% |
| | TA6/TA7 | | | G/G | | | 0 | 2 | 2 | 0.0% | 100.0% |
| | | G/G | T9/9 | | | | 0 | 2 | 2 | 0.0% | 100.0% |
| | | G/G | | G/G | | | 0 | 2 | 2 | 0.0% | 100.0% |
| | TA6/TA6 | | T9/9 | | | T/G | 0 | 2 | 2 | 0.0% | 100.0% |
| | TA6/TA6 | | | G/G | | T/G | 0 | 2 | 2 | 0.0% | 100.0% |
| | TA6/TA6 | G/A | | | T/G | T/G | 0 | 2 | 2 | 0.0% | 100.0% |
| | | A/A | | | | | 0 | 1 | 1 | 0.0% | 100.0% |
| | TA6/TA6 | | | | G/G | | 0 | 1 | 1 | 0.0% | 100.0% |
| | TA6/TA7 | | | | G/G | | 0 | 1 | 1 | 0.0% | 100.0% |
| | | | T9/9 | | T/T | | 0 | 1 | 1 | 0.0% | 100.0% |
| | | | T9/9 | | | T/T | 0 | 1 | 1 | 0.0% | 100.0% |
| | | | | G/G | T/T | | 0 | 1 | 1 | 0.0% | 100.0% |
| | | | | G/G | | T/T | 0 | 1 | 1 | 0.0% | 100.0% |
| | | | | | T/T | G/G | 0 | 1 | 1 | 0.0% | 100.0% |
| | | | | | G/G | T/T | 0 | 1 | 1 | 0.0% | 100.0% |
| | | | | | G/G | T/G | 0 | 1 | 1 | 0.0% | 100.0% |
| | TA6/TA6 | G/G | T9/9 | | | | 0 | 1 | 1 | 0.0% | 100.0% |
| | TA6/TA7 | G/G | T9/9 | | | | 0 | 1 | 1 | 0.0% | 100.0% |
| | TA6/TA7 | G/A | T9/10 | | | | 0 | 1 | 1 | 0.0% | 100.0% |
| | TA6/TA7 | G/A | T9/9 | | | | 0 | 1 | 1 | 0.0% | 100.0% |
| | TA6/TA6 | G/G | | G/G | | | 0 | 1 | 1 | 0.0% | 100.0% |
| | TA6/TA7 | G/G | | G/G | | | 0 | 1 | 1 | 0.0% | 100.0% |
| | TA6/TA7 | G/A | | T/G | | | 0 | 1 | 1 | 0.0% | 100.0% |
| | TA6/TA7 | G/A | | G/G | | | 0 | 1 | 1 | 0.0% | 100.0% |
| | TA6/TA6 | G/G | | | | T/G | 0 | 1 | 1 | 0.0% | 100.0% |
| | TA6/TA7 | | T9/9 | | T/G | | 0 | 1 | 1 | 0.0% | 100.0% |
| | TA6/TA7 | | | G/G | T/G | | 0 | 1 | 1 | 0.0% | 100.0% |
| | | G/A | T9/10 | | T/G | | 0 | 1 | 1 | 0.0% | 100.0% |
| | | G/G | T9/9 | | | T/G | 0 | 1 | 1 | 0.0% | 100.0% |
| | | G/A | | T/G | T/G | | 0 | 1 | 1 | 0.0% | 100.0% |
| | | G/G | | G/G | | T/G | 0 | 1 | 1 | 0.0% | 100.0% |
| | TA6/TA6 | | T9/10 | | T/G | T/G | 0 | 1 | 1 | 0.0% | 100.0% |
| | TA6/TA6 | | | T/G | T/G | T/G | 0 | 1 | 1 | 0.0% | 100.0% |
| | | | T9/9 | | | | 1 | 6 | 7 | 14.3% | 85.7% |
| | | | | G/G | | | 1 | 6 | 7 | 14.3% | 85.7% |
| | | | | | T/G | T/G | 1 | 6 | 7 | 14.3% | 85.7% |
| | TA6/TA6 | | T9/9 | | | | 1 | 4 | 5 | 20.0% | 80.0% |
| | TA6/TA6 | | | G/G | | | 1 | 4 | 5 | 20.0% | 80.0% |
| | TA6/TA7 | | | | | T/G | 1 | 4 | 5 | 20.0% | 80.0% |
| | | G/A | | | T/G | | 1 | 4 | 5 | 20.0% | 80.0% |
| | | G/A | T9/9 | | | | 1 | 3 | 4 | 25.0% | 75.0% |
| | | G/A | | G/G | | | 1 | 3 | 4 | 25.0% | 75.0% |
| | | G/G | | | | T/G | 1 | 3 | 4 | 25.0% | 75.0% |

TABLE 16

| | UGT1A1*28 | UGT1A1*6 | UGT1A9*22 | UGT1A7 | UGT1A1*60 | UGT1A7 | Case count | | | Share rate | |
|---|---|---|---|---|---|---|---|---|---|---|---|
| 1st line | −53(TA) | 211G/A | −118T | N129K | −3279 T/G | −57 T/G | G0-2 | G3.4 | total | G0-2 | G3.4 |
| adverse effect present (cont.) | | | | | | | | | | | |
| | | | T9/9 | | T/G | | 1 | 3 | 4 | 25.0% | 75.0% |
| | | | | G/G | T/G | | 1 | 3 | 4 | 25.0% | 75.0% |
| | TA6/TA7 | | | | T/G | T/G | 1 | 3 | 4 | 25.0% | 75.0% |
| | | | T9/10 | | T/G | T/G | 1 | 3 | 4 | 25.0% | 75.0% |
| | | | | T/G | T/G | T/G | 1 | 3 | 4 | 25.0% | 75.0% |
| 59 formulae total | | | | | | | 2 | 9 | 11 | 18.2% | 81.8% |
| optimization at level of at least 70% | | | | | | | | | | | |
| | | | T9/9 | | | | 1 | 6 | 7 | 14.3% | 85.7% |
| | | | | | T/G | T/G | 1 | 6 | 7 | 14.3% | 85.7% |
| 2 formulae total | | | | | | | 2 | 9 | 11 | 18.2% | 81.8% |
| optimization at level of at least 80% | | | | | | | | | | | |
| | | | T9/9 | | | | 1 | 6 | 7 | 14.3% | 85.7% |
| | | | | | T/G | T/G | 1 | 6 | 7 | 14.3% | 85.7% |
| 2 formulae total | | | | | | | 2 | 9 | 11 | 18.2% | 81.8% |
| optimiztion at level of at least 100% | | | | | | | | | | | |
| | | | T9/9 | | | T/G | 0 | 4 | 4 | 0.0% | 100.0% |
| | | A/A | | | | | 0 | 1 | 1 | 0.0% | 100.0% |
| | | | | | G/G | | 0 | 2 | 2 | 0.0% | 100.0% |
| | TA6/TA7 | G/A | | | | | 0 | 2 | 2 | 0.0% | 100.0% |
| | TA6/TA6 | G/G | | | | T/G | 0 | 1 | 1 | 0.0% | 100.0% |

| | | | | | |
|---|---|---|---|---|---|
| 5 formulae total | 0 | 8 | 8 | 0.0% | 100.0% |

TABLE 17

| | UGT1A1*28 | UGT1A1*6 | UGT1A9*22 | UGT1A7 | UGT1A1*60 | UGT1A7 | Case count | | | Share rate | |
|---|---|---|---|---|---|---|---|---|---|---|---|
| 2nd line | −53(TA) | 211G/A | −118T | N129K | −3279 T/G | −57 T/G | CR/PR | SD/PD | total | CR/PR | SD/PD |

| effective | | | | | | |
|---|---|---|---|---|---|---|
| | A/A | 1 | 0 | 1 | 100.0% | 0.0% |
| 1 formula total | | 1 | 0 | 1 | 100.0% | 0.0% |
| optimization at level of at least 70% | | | | | | |
| | A/A | 1 | 0 | 1 | 100.0% | 0.0% |
| 1 formula total | | 1 | 0 | 1 | 100.0% | 0.0% |
| optimization at level of at least 80% | | | | | | |
| | A/A | 1 | 0 | 1 | 100.0% | 0.0% |
| 1 formula total | | 1 | 0 | 1 | 100.0% | 0.0% |
| optimiztion at level of at least 100% | | | | | | |
| | A/A | 1 | 0 | 1 | 100.0% | 0.0% |

| | | | | | |
|---|---|---|---|---|---|
| 1 formula total | 1 | 0 | 1 | 100.0% | 0.0% |

TABLE 18

| 2nd line | UGT1A1*28 | UGT1A1*6 | UGT1A9*22 | UGT1A7 | UGT1A1*60 | UGT1A7 | Case count | | | Share rate | |
|---|---|---|---|---|---|---|---|---|---|---|---|
| ineffective | −53(TA) | 211G/A | −118T | N129K | −3279 T/G | −57 T/G | CR/PR | SD/PD | total | CR/PR | SD/PD |
| | | | | | T/G | | 0 | 12 | 12 | 0.0% | 100.0% |
| | | G/G | | | T/G | | 0 | 10 | 10 | 0.0% | 100.0% |
| | | G/G | T9/10 | | | | 0 | 9 | 9 | 0.0% | 100.0% |
| | | G/G | | T/G | | | 0 | 9 | 9 | 0.0% | 100.0% |
| | TA6/TA7 | | | | | | 0 | 8 | 8 | 0.0% | 100.0% |
| | | | T9/10 | | T/G | | 0 | 8 | 8 | 0.0% | 100.0% |
| | | | | T/G | T/G | | 0 | 8 | 8 | 0.0% | 100.0% |
| | TA6/TA7 | G/G | | | | | 0 | 7 | 7 | 0.0% | 100.0% |
| | | | | | T/G | T/T | 0 | 7 | 7 | 0.0% | 100.0% |
| | | G/G | T9/10 | | T/G | | 0 | 7 | 7 | 0.0% | 100.0% |
| | | G/G | | T/G | T/G | | 0 | 7 | 7 | 0.0% | 100.0% |
| | TA6/TA6 | | | | T/G | | 0 | 6 | 6 | 0.0% | 100.0% |
| | TA6/TA7 | | | | T/G | | 0 | 6 | 6 | 0.0% | 100.0% |
| | | | T9/10 | | | T/T | 0 | 6 | 6 | 0.0% | 100.0% |
| | | | | T/G | | T/T | 0 | 6 | 6 | 0.0% | 100.0% |
| | TA6/TA6 | G/G | T9/10 | | | | 0 | 6 | 6 | 0.0% | 100.0% |
| | TA6/TA6 | G/G | | T/G | | | 0 | 6 | 5 | 0.0% | 100.0% |
| | TA6/TA6 | G/G | | | T/G | | 0 | 5 | 5 | 0.0% | 100.0% |
| | TA6/TA7 | G/G | | | T/G | | 0 | 5 | 5 | 0.0% | 100.0% |
| | TA6/TA6 | | T9/10 | | T/G | | 0 | 5 | 5 | 0.0% | 100.0% |
| | TA6/TA6 | | T9/10 | | | T/T | 0 | 5 | 5 | 0.0% | 100.0% |
| | TA6/TA6 | | | T/G | T/G | | 0 | 5 | 5 | 0.0% | 100.0% |
| | TA6/TA6 | | | T/G | | T/T | 0 | 5 | 5 | 0.0% | 100.0% |
| | TA6/TA6 | | | | T/G | T/T | 0 | 5 | 5 | 0.0% | 100.0% |
| | | | T9/10 | | T/G | T/T | 0 | 5 | 5 | 0.0% | 100.0% |
| | | | | T/G | T/G | T/T | 0 | 5 | 5 | 0.0% | 100.0% |
| | TA6/TA7 | | T9/10 | | | | 0 | 4 | 4 | 0.0% | 100.0% |
| | TA6/TA7 | | | T/G | | | 0 | 4 | 4 | 0.0% | 100.0% |
| | TA6/TA7 | | | | | T/T | 0 | 4 | 4 | 0.0% | 100.0% |
| | | | | | T/G | T/G | 0 | 4 | 4 | 0.0% | 100.0% |
| | TA6/TA7 | | | | | T/G | 0 | 3 | 3 | 0.0% | 100.0% |
| | | G/G | | | | T/G | 0 | 3 | 3 | 0.0% | 100.0% |
| | TA6/TA7 | G/G | T9/10 | | | | 0 | 3 | 3 | 0.0% | 100.0% |
| | TA6/TA7 | G/G | | T/G | | | 0 | 3 | 3 | 0.0% | 100.0% |
| | TA6/TA7 | | T9/10 | | T/G | | 0 | 3 | 3 | 0.0% | 100.0% |
| | TA6/TA7 | | | T/G | T/G | | 0 | 3 | 3 | 0.0% | 100.0% |
| | | | T9/10 | | T/G | T/G | 0 | 3 | 3 | 0.0% | 100.0% |
| | | | | T/G | T/G | T/G | 0 | 3 | 3 | 0.0% | 100.0% |
| | | | | | G/G | | 0 | 2 | 2 | 0.0% | 100.0% |
| | TA6/TA7 | | T10/10 | | | | 0 | 2 | 2 | 0.0% | 100.0% |
| | TA6/TA7 | | T9/9 | | | | 0 | 2 | 2 | 0.0% | 100.0% |
| | TA6/TA7 | | | T/T | | | 0 | 2 | 2 | 0.0% | 100.0% |
| | TA6/TA7 | | | G/G | | | 0 | 2 | 2 | 0.0% | 100.0% |
| | | G/G | T9/9 | | | | 0 | 2 | 2 | 0.0% | 100.0% |
| | | G/A | T9/9 | | | | 0 | 2 | 2 | 0.0% | 100.0% |
| | | G/G | | G/G | | | 0 | 2 | 2 | 0.0% | 100.0% |
| | | G/A | | G/G | | | 0 | 2 | 2 | 0.0% | 100.0% |
| | | G/A | | | T/G | | 0 | 2 | 2 | 0.0% | 100.0% |
| | | | T10/10 | | T/G | | 0 | 2 | 2 | 0.0% | 100.0% |
| | | | T9/9 | | T/G | | 0 | 2 | 2 | 0.0% | 100.0% |
| | | | | T/T | T/G | | 0 | 2 | 2 | 0.0% | 100.0% |
| | | | | G/G | T/G | | 0 | 2 | 2 | 0.0% | 100.0% |
| | TA6/TA7 | G/G | | | | T/G | 0 | 2 | 2 | 0.0% | 100.0% |
| | TA6/TA7 | | | | T/G | T/T | 0 | 2 | 2 | 0.0% | 100.0% |

TABLE 19

| 2nd line | UGT1A1*28 | UGT1A1*6 | UGT1A9*22 | UGT1A7 | UGT1A1*60 | UGT1A7 | Case count | | | Share rate | |
|---|---|---|---|---|---|---|---|---|---|---|---|
| ineffective (cont.) | −53(TA) | 211G/A | −118T | N129K | −3279 T/G | −57 T/G | CR/PR | SD/PD | total | CR/PR | SD/PD |
| | | G/G | | | T/G | T/G | 0 | 2 | 2 | 0.0% | 100.0% |
| | TA6/TA7 | G/G | T9/10 | | T/G | | 0 | 2 | 2 | 0.0% | 100.0% |
| | TA6/TA7 | G/G | | T/G | T/G | | 0 | 2 | 2 | 0.0% | 100.0% |
| | TA6/TA7 | G/A | | | | | 0 | 1 | 1 | 0.0% | 100.0% |
| | TA6/TA7 | | | | | G/G | 0 | 1 | 1 | 0.0% | 100.0% |
| | | G/G | | | | G/G | 0 | 1 | 1 | 0.0% | 100.0% |
| | | G/A | | | | G/G | 0 | 1 | 1 | 0.0% | 100.0% |
| | | | T9/10 | | G/G | | 0 | 1 | 1 | 0.0% | 100.0% |
| | | | T9/9 | | G/G | | 0 | 1 | 1 | 0.0% | 100.0% |
| | | | T9/9 | | | T/T | 0 | 1 | 1 | 0.0% | 100.0% |
| | | | T9/9 | | | T/G | 0 | 1 | 1 | 0.0% | 100.0% |
| | | | | T/G | G/G | | 0 | 1 | 1 | 0.0% | 100.0% |
| | | | | G/G | G/G | | 0 | 1 | 1 | 0.0% | 100.0% |
| | | | | G/G | | T/T | 0 | 1 | 1 | 0.0% | 100.0% |
| | | | | G/G | | T/G | 0 | 1 | 1 | 0.0% | 100.0% |
| | | | | | T/G | G/G | 0 | 1 | 1 | 0.0% | 100.0% |
| | TA6/TA6 | G/A | | | T/G | | 0 | 1 | 1 | 0.0% | 100.0% |
| | TA6/TA6 | G/G | | | | T/G | 0 | 1 | 1 | 0.0% | 100.0% |
| | TA6/TA6 | | T9/9 | | T/G | | 0 | 1 | 1 | 0.0% | 100.0% |
| | TA6/TA7 | | T9/9 | | T/G | | 0 | 1 | 1 | 0.0% | 100.0% |
| | TA6/TA7 | | T9/10 | | | T/T | 0 | 1 | 1 | 0.0% | 100.0% |
| | TA6/TA6 | | | G/G | T/G | | 0 | 1 | 1 | 0.0% | 100.0% |
| | TA6/TA7 | | | G/G | T/G | | 0 | 1 | 1 | 0.0% | 100.0% |
| | TA6/TA7 | | | T/G | | T/T | 0 | 1 | 1 | 0.0% | 100.0% |
| | TA6/TA6 | | | | T/G | T/G | 0 | 1 | 1 | 0.0% | 100.0% |
| | | G/G | T9/10 | | T/T | | 0 | 1 | 1 | 0.0% | 100.0% |
| | | G/G | T9/9 | | T/G | | 0 | 1 | 1 | 0.0% | 100.0% |
| | | G/A | T9/10 | | T/G | | 0 | 1 | 1 | 0.0% | 100.0% |
| | | G/A | T9/9 | | T/T | | 0 | 1 | 1 | 0.0% | 100.0% |
| | | G/A | T9/9 | | T/G | | 0 | 1 | 1 | 0.0% | 100.0% |
| | | G/G | | T/G | T/T | | 0 | 1 | 1 | 0.0% | 100.0% |
| | | G/G | | G/G | T/G | | 0 | 1 | 1 | 0.0% | 100.0% |
| | | G/A | | T/G | T/G | | 0 | 1 | 1 | 0.0% | 100.0% |
| | | G/A | | G/G | T/T | | 0 | 1 | 1 | 0.0% | 100.0% |
| | | G/A | | G/G | T/G | | 0 | 1 | 1 | 0.0% | 100.0% |
| | | G/G | | | T/T | T/G | 0 | 1 | 1 | 0.0% | 100.0% |
| | | G/G | | | | | 2 | 21 | 23 | 8.7% | 91.3% |
| | | | | | | T/T | 2 | 17 | 19 | 10.5% | 89.5% |
| | TA6/TA6 | G/G | | | | | 2 | 14 | 16 | 12.5% | 87.5% |
| | TA6/TA6 | | | | | T/T | 2 | 13 | 15 | 13.3% | 86.7% |
| | | | T9/10 | | | | 3 | 15 | 18 | 16.7% | 83.3% |
| | | | | T/G | | | 3 | 15 | 18 | 16.7% | 83.3% |
| | | | T10/10 | | | | 2 | 10 | 12 | 16.7% | 83.3% |
| | | | | T/T | | | 2 | 10 | 12 | 16.7% | 83.3% |
| | | G/G | | | T/T | | 2 | 9 | 11 | 18.2% | 81.8% |
| | TA6/TA6 | | T10/10 | | | | 2 | 8 | 10 | 20.0% | 80.0% |
| | TA6/TA6 | | | T/T | | | 2 | 8 | 10 | 20.0% | 80.0% |
| | | | T10/10 | | T/T | | 2 | 8 | 10 | 20.0% | 80.0% |
| | | | | T/T | T/T | | 2 | 8 | 10 | 20.0% | 80.0% |
| | | | | | T/T | T/T | 2 | 8 | 10 | 20.0% | 80.0% |
| | | | T9/9 | | | | 1 | 4 | 5 | 20.0% | 80.0% |
| | | | | G/G | | | 1 | 4 | 5 | 20.0% | 80.0% |
| | TA6/TA6 | | T9/10 | | | | 3 | 11 | 14 | 21.4% | 78.6% |
| | TA6/TA6 | | | T/G | | | 3 | 11 | 14 | 21.4% | 78.6% |

TABLE 20

| | UGT1A1*28 | UGT1A1*6 | UGT1A9*22 | UGT1A7 | UGT1A1*60 | UGT1A7 | Case count | | | Share rate | |
|---|---|---|---|---|---|---|---|---|---|---|---|
| 2nd line | −53(TA) | 211G/A | −118T | N129K | −3279 T/G | −57 T/G | CR/PR | SD/PD | total | CR/PR | SD/PD |
| ineffective (cont.) | | | | | | | | | | | |
| | TA6/TA6 | | | | | | 6 | 21 | 27 | 22.2% | 77.8% |
| | | | | | | T/G | 3 | 10 | 13 | 23.1% | 76.9% |
| | | | T9/10 | | | T/G | 3 | 9 | 12 | 25.0% | 75.0% |
| | | | | T/G | | T/G | 3 | 9 | 12 | 25.0% | 75.0% |
| | | G/A | | | | | 3 | 8 | 11 | 27.3% | 72.7% |
| | | | | | T/T | | 6 | 15 | 21 | 28.6% | 71.4% |
| | TA6/TA6 | G/A | | | | | 3 | 7 | 10 | 30.0% | 70.0% |
| | TA6/TA6 | | | | | T/G | 3 | 7 | 10 | 30.0% | 70.0% |
| | | G/A | | | | T/G | 3 | 7 | 10 | 30.0% | 70.0% |
| 117 formulae total | | | | | | | 6 | 29 | 35 | 17.1% | 82.9% |
| optimization at level of at least 70% | | | | | | | | | | | |
| | | G/G | | | | | 2 | 21 | 23 | 8.7% | 91.3% |
| | | G/A | | | | | 3 | 8 | 11 | 27.3% | 72.7% |
| 2 formulae total | | | | | | | 5 | 29 | 34 | 14.7% | 85.3% |
| optimization at level of at least 80% | | | | | | | | | | | |
| | | G/G | | | | | 2 | 21 | 23 | 8.7% | 91.3% |
| | | | T9/10 | | | | 3 | 15 | 18 | 16.7% | 83.3% |
| | | G/A | T9/9 | | | | 0 | 2 | 2 | 0.0% | 100.0% |
| 3 formulae total | | | | | | | 5 | 29 | 34 | 14.7% | 85.3% |
| optimiztion at level of at least 100% | | | | | | | | | | | |
| | TA6/TA7 | | | | | | 0 | 8 | 8 | 0.0% | 100.0% |
| | | G/G | T9/10 | | | | 0 | 9 | 9 | 0.0% | 100.0% |
| | | G/A | T9/9 | | | | 0 | 2 | 2 | 0.0% | 100.0% |

| | | | | | |
|---|---|---|---|---|---|
| 3 formulae total | 0 | 16 | 16 | 0.0% | 100.0% |

TABLE 21

| 2nd line | UGT1A1*28 | UGT1A1*6 | UGT1A9*22 | UGT1A7 | UGT1A1*60 | UGT1A7 | Case count | | | Share rate | |
|---|---|---|---|---|---|---|---|---|---|---|---|
| adverse effect free | −53(TA) | 211G/A | −118T | N129K | −3279 T/G | −57 T/G | G0-2 | G3.4 | total | G0-2 | G3.4 |
| | | | | | G/G | | 2 | 0 | 2 | 100.0% | 0.0% |
| | TA6/TA7 | | T9/9 | | | | 2 | 0 | 2 | 100.0% | 0.0% |
| | TA6/TA7 | | | G/G | | | 2 | 0 | 2 | 100.0% | 0.0% |
| | | G/G | T9/9 | | | | 2 | 0 | 2 | 100.0% | 0.0% |
| | | G/A | T9/9 | | | | 2 | 0 | 2 | 100.0% | 0.0% |
| | | G/G | | G/G | | | 2 | 0 | 2 | 100.0% | 0.0% |
| | | G/A | | G/G | | | 2 | 0 | 2 | 100.0% | 0.0% |
| | | | T9/9 | | T/G | | 2 | 0 | 2 | 100.0% | 0.0% |
| | | | | G/G | T/G | | 2 | 0 | 2 | 100.0% | 0.0% |
| | TA6/TA7 | | | | | G/G | 1 | 0 | 1 | 100.0% | 0.0% |
| | | G/G | | | | G/G | 1 | 0 | 1 | 100.0% | 0.0% |
| | | G/A | | | | G/G | 1 | 0 | 1 | 100.0% | 0.0% |
| | | | T9/10 | | G/G | | 1 | 0 | 1 | 100.0% | 0.0% |
| | | | T9/9 | | G/G | | 1 | 0 | 1 | 100.0% | 0.0% |
| | | | T9/9 | | | T/T | 1 | 0 | 1 | 100.0% | 0.0% |
| | | | T9/9 | | | T/G | 1 | 0 | 1 | 100.0% | 0.0% |
| | | | | T/G | G/G | | 1 | 0 | 1 | 100.0% | 0.0% |
| | | | | G/G | G/G | | 1 | 0 | 1 | 100.0% | 0.0% |
| | | | | G/G | | T/T | 1 | 0 | 1 | 100.0% | 0.0% |
| | | | | G/G | | T/G | 1 | 0 | 1 | 100.0% | 0.0% |
| | | | | | T/G | G/G | 1 | 0 | 1 | 100.0% | 0.0% |
| | TA6/TA6 | G/A | | | T/G | | 1 | 0 | 1 | 100.0% | 0.0% |
| | TA6/TA6 | G/G | | | | T/G | 1 | 0 | 1 | 100.0% | 0.0% |
| | TA6/TA6 | | T9/9 | | T/G | | 1 | 0 | 1 | 100.0% | 0.0% |
| | TA6/TA7 | | T9/9 | | T/G | | 1 | 0 | 1 | 100.0% | 0.0% |
| | TA6/TA7 | | T9/10 | | | T/T | 1 | 0 | 1 | 100.0% | 0.0% |
| | TA6/TA6 | | | G/G | T/G | | 1 | 0 | 1 | 100.0% | 0.0% |
| | TA6/TA7 | | | G/G | T/G | | 1 | 0 | 1 | 100.0% | 0.0% |
| | TA6/TA7 | | | T/G | | T/T | 1 | 0 | 1 | 100.0% | 0.0% |
| | TA6/TA6 | | | | T/G | T/G | 1 | 0 | 1 | 100.0% | 0.0% |
| | | G/G | T9/10 | | T/T | | 1 | 0 | 1 | 100.0% | 0.0% |
| | | G/G | T9/9 | | T/G | | 1 | 0 | 1 | 100.0% | 0.0% |
| | | G/A | T9/9 | | T/T | | 1 | 0 | 1 | 100.0% | 0.0% |
| | | G/A | T9/9 | | T/G | | 1 | 0 | 1 | 100.0% | 0.0% |
| | | G/G | | T/G | T/T | | 1 | 0 | 1 | 100.0% | 0.0% |
| | | G/G | | G/G | T/G | | 1 | 0 | 1 | 100.0% | 0.0% |
| | | G/A | | G/G | T/T | | 1 | 0 | 1 | 100.0% | 0.0% |
| | | G/A | | G/G | T/G | | 1 | 0 | 1 | 100.0% | 0.0% |
| | | G/G | | | T/T | T/G | 1 | 0 | 1 | 100.0% | 0.0% |
| | | G/G | | | T/T | | 9 | 2 | 11 | 81.8% | 18.2% |
| | TA6/TA6 | | T10/10 | | | | 8 | 2 | 10 | 80.0% | 20.0% |
| | TA6/TA6 | | | T/T | | | 8 | 2 | 10 | 80.0% | 20.0% |
| | | | T10/10 | | T/T | | 8 | 2 | 10 | 80.0% | 20.0% |
| | | | | T/T | T/T | | 8 | 2 | 10 | 80.0% | 20.0% |
| | | | | | T/T | T/T | 8 | 2 | 10 | 80.0% | 20.0% |
| | | | T9/9 | | | | 4 | 1 | 5 | 80.0% | 20.0% |
| | | | | G/G | | | 4 | 1 | 5 | 80.0% | 20.0% |
| | | | T10/10 | | | | 9 | 3 | 12 | 75.0% | 25.0% |
| | | | | T/T | | | 9 | 3 | 12 | 75.0% | 25.0% |
| | TA6/TA7 | | | | | T/T | 3 | 1 | 4 | 75.0% | 25.0% |
| | TA6/TA7 | G/G | | | | | 5 | 2 | 7 | 75.0% | 25.0% |

| | | | | | |
|---|---|---|---|---|---|
| 51 formulae total | 16 | 5 | 21 | 76.2% | 23.3% |

TABLE 22

| | UGT1A1*28 | UGT1A1*6 | UGT1A9*22 | UGT1A7 | UGT1A1*60 | UGT1A7 | [symbol] | | | [symbol] | |
|---|---|---|---|---|---|---|---|---|---|---|---|
| 2nd line | −53(TA) | 211G/A | −118T | N129K | −3279 T/G | −57 T/G | G0-2 | G3.4 | [symbol] | G0-2 | G3.4 |
| adverse effect free | | | | | | | | | | | |
| optimization at level of at least 70% | | | | | | | | | | | |
| | | G/G | | | T/T | | 9 | 2 | 11 | 81.8% | 18.2% |
| | TA6/TA7 | G/G | | | | | 5 | 2 | 7 | 71.4% | 28.6% |
| | | G/A | T9/9 | | | | 2 | 0 | 2 | 100.0% | 0.0% |
| 3 formulae total | | | | | | | 16 | 4 | 20 | 80.0% | 20.0% |
| optimization at level of at least 80% | | | | | | | | | | | |
| | | G/G | | | T/T | | 9 | 2 | 11 | 81.8% | 18.2% |
| | | | T9/9 | | | | 4 | 1 | 5 | 80.0% | 20.0% |
| | | | | | G/G | | 2 | 0 | 2 | 100.0% | 0.0% |
| 3 formulae total | | | | | | | 14 | 3 | 17 | 82.4% | 17.6% |
| optimiztion at level of at least 100% | | | | | | | | | | | |
| | | | | | G/G | | 2 | 0 | 2 | 100.0% | 0.0% |
| | | G/A | T9/9 | | | | 2 | 0 | 2 | 100.0% | 0.0% |
| | TA6/TA7 | | T9/9 | | | | 2 | 0 | 2 | 100.0% | 0.0% |
| | TA6/TA6 | G/G | | | | T/G | 1 | 0 | 1 | 100.0% | 0.0% |

| | | | | | |
|---|---|---|---|---|---|
| 4 formulae total | 6 | 0 | 6 | 100.0% | 0.0% |

TABLE 23

| | UGT1A1*28 | UGT1A1*6 | UGT1A9*22 | UGT1A7 | UGT1A1*60 | UGT1A7 | Case count | | | Share rate | |
|---|---|---|---|---|---|---|---|---|---|---|---|
| 2nd line | −53(TA) | 211G/A | −118T | N129K | −3279 T/G | −57 T/G | G0-2 | G3.4 | total | G0-2 | G3.4 |
| adverse effect present | | | | | | | | | | | |
| | | A/A | | | | | 0 | 1 | 1 | 0.0% | 100.0% |
| | TA6/TA7 | G/A | | | | | 0 | 1 | 1 | 0.0% | 100.0% |
| | | G/A | T9/10 | | T/G | | 0 | 1 | 1 | 0.0% | 100.0% |
| | | G/A | | T/G | T/G | | 0 | 1 | 1 | 0.0% | 100.0% |
| | TA6/TA6 | G/G | | | T/G | | 1 | 4 | 5 | 20.0% | 80.0% |
| | TA6/TA6 | | T9/10 | | T/G | | 1 | 4 | 5 | 20.0% | 80.0% |
| | TA6/TA6 | | T9/10 | | | T/T | 1 | 4 | 5 | 20.0% | 80.0% |
| | TA6/TA6 | | | T/G | T/G | | 1 | 4 | 5 | 20.0% | 80.0% |
| | TA6/TA6 | | | T/G | | T/T | 1 | 4 | 5 | 20.0% | 80.0% |
| | TA6/TA6 | | | | T/G | T/T | 1 | 4 | 5 | 20.0% | 80.0% |
| | | | T9/10 | | T/G | T/T | 1 | 4 | 5 | 20.0% | 80.0% |
| | | | | T/G | T/G | T/T | 1 | 4 | 5 | 20.0% | 80.0% |
| | | G/A | T9/10 | | | | 2 | 7 | 9 | 22.2% | 77.8% |
| | | G/A | | T/G | | | 2 | 7 | 9 | 22.2% | 77.8% |
| | | | T9/10 | | T/G | | 2 | 6 | 8 | 25.0% | 75.0% |
| | | | | T/G | T/G | | 2 | 6 | 8 | 25.0% | 75.0% |
| | TA6/TA6 | G/A | T9/10 | | | | 2 | 5 | 8 | 25.0% | 75.0% |
| | TA6/TA6 | G/A | | T/G | | | 2 | 6 | 8 | 25.0% | 75.0% |
| | | G/A | T9/10 | | T/T | | 2 | 6 | 8 | 25.0% | 75.0% |
| | | G/A | | T/G | T/T | | 2 | 6 | 8 | 25.0% | 75.0% |
| | | G/A | | | T/T | T/G | 2 | 6 | 8 | 25.0% | 75.0% |
| | TA6/TA6 | | T9/10 | | | | 4 | 10 | 14 | 28.6% | 71.4% |
| | TA6/TA6 | | | T/G | | | 4 | 10 | 14 | 28.6% | 71.4% |
| | | | | | T/G | T/T | 2 | 5 | 7 | 28.6% | 71.4% |
| | | G/G | T9/10 | | T/G | | 2 | 5 | 7 | 28.6% | 71.4% |
| | | G/G | | T/G | T/G | | 2 | 5 | 7 | 28.6% | 71.4% |
| | | G/A | | | | T/G | 3 | 7 | 10 | 30.0% | 70.0% |
| 27 formulae total | | | | | | | 7 | 14 | 21 | 33.3% | 66.7% |
| optimization at level of at least 70% | | | | | | | | | | | |
| | TA6/TA6 | | T9/10 | | | | 4 | 10 | 14 | 28.6% | 71.4 |
| | | | T9/10 | | T/G | | 2 | 6 | 8 | 25.0% | 75.0% |
| | | A/A | | | | | 0 | 1 | 1 | 0.0% | 100.0% |
| | | | | | T/G | T/T | 2 | 5 | 7 | 28.6% | 71.4% |
| 4 formulae total | | | | | | | 6 | 14 | 20 | 30.0% | 70.0% |
| optimization at level of at least 80% | | | | | | | | | | | |
| | TA6/TA6 | G/G | | | T/G | | 1 | 4 | 5 | 20.0% | 80.0% |
| | | A/A | | | | | 0 | 1 | 1 | 0.0% | 100.0% |
| | TA6/TA7 | G/A | | | | | 0 | 1 | 1 | 0.0% | 100.0% |
| 3 formulae total | | | | | | | 1 | 6 | 7 | 14.3% | 85.7% |
| optimiztion at level of at least 100% | | | | | | | | | | | |
| | | A/A | | | | | 0 | 1 | 1 | 0.0% | 100.0% |
| | TA6/TA7 | G/A | | | | | 0 | 1 | 1 | 0.0% | 100.0% |

| | | | | | |
|---|---|---|---|---|---|
| 2 formulae total | 0 | 2 | 2 | 0.0% | 100.0% |

TABLE 24
1st line

| | | Case | Share | Confidence | | |
|---|---|---|---|---|---|---|
| | | count | rate | 100% | 100% | 100% |
| effectiveness | effective | 18 | 50.0% | 8 - 0 | 8 - 0 | 11 - 3 |
| | ineffective | 18 | 50.0% | 6 - 0 | 6 - 0 | 10 - 2 |
| adverse | adverse effect | 20 | 52.6% | 4 - 0 | 4 - 0 | 16 - 6 |
| effect | free | | | | | |
| | adverse effect | 18 | 47.4% | 8 - 0 | 9 - 2 | 9 - 2 |
| | present | | | | | |

2nd line

| | | Case | Share | Confidence | | |
|---|---|---|---|---|---|---|
| | | count | rate | 100% | 100% | 100% |
| effectiveness | effective | 6 | 17.1% | 1 - 0 | 1 - 0 | 1 - 0 |
| | ineffective | 29 | 82.9% | 16 - 0 | 29 - 5 | 29 - 5 |
| adverse | adverse effect | 19 | 54.3% | 6 - 0 | 14 - 3 | 16 - 4 |
| effect | free | | | | | |
| | adverse effect | 16 | 45.7% | 2 - 0 | 6 - 1 | 14 - 6 |
| | present | | | | | |

Total

| | | Case | Share | Confidence | | |
|---|---|---|---|---|---|---|
| | | count | rate | 100% | 80% | 70% |
| effectiveness | effective | 24 | 33.8% | 9 - 0 | 9 - 0 | 12 - 3 |
| | ineffective | 47 | 66.2% | 22 - 0 | 35 - 5 | 39 - 7 |
| adverse | adverse effect | 39 | 53.4% | 10 - 0 | 18 - 3 | 32 - 10 |
| effect | free | | | | | |
| | adverse effect | 34 | 46.6% | 10 - 0 | 15 - 3 | 23 - 8 |
| | present | | | | | |

(correct classification count - error classification count)

Upon comparison to Example 1, prediction performance was improved by segregation of the 1st line and the 2nd line. The prediction performance was improved by applying non-genotype gene conditions to the prediction of drug effects-adverse effects. According to the present invention, it is possible to generate a discrimination formula having high predictive ability by performing segregation according to, for example, sex, presence-absence of other diseases, age bracket, or the like.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### INDUSTRIAL APPLICABILITY

The present invention is applicable to the medical treatment field and bioinformatics field. Use is possible for novel drug research and development by drug manufacturers, testing and research relating to drug effects-adverse effects at such manufacturers and research institutions (including universities or the like), and use is possible for clinical or medical treatment activities at medical organizations.

### DESCRIPTION OF REFERENCE CHARACTERS

1 . . . drug effect-adverse effect prediction system
2 . . . discrimination formula design part
3 . . . database
4 . . . prediction part
5 . . . clinical data analysis table generating part
6 . . . reliability analysis part
7 . . . discrimination formula generating part
8 . . . discrimination formula optimizing part
10 . . . clinical data
11 . . . analysis table
12 . . . discrimination formula data
13 . . . classification result
14 . . . prediction result
15 . . . patient
16 . . . medical knowledge condition

What is claimed is:

1. A drug effect-adverse effect prediction system comprising:
a clinical data analysis table generating part, for each combination of genotypes (referred to hereinafter as the “gene conditions”) relating to a drug effect or adverse effect, for generation of an analysis table for handling cases related to presence or absence of the drug effect or adverse effect;
a reliability analysis part for selecting at least one of the gene conditions from among the gene conditions in the analysis table and calculating a share rate for a case count concerning the presence or absence of the effect or adverse effect;
a discrimination formula generating part for extracting corresponding gene conditions from the gene conditions resulting from the share rate calculated by the reliability analysis part based on a desired threshold value for the share rate and a desired threshold value for presence or absence in the case count, and for generating a discrimination formula using the extracted gene condition either as the single extracted gene condition or as a combination of the extracted gene conditions;
a prediction part, for each gene condition included in the discrimination formula, for performing comparison checking of data relating to the genotype of a specimen relating to the presence or absence of the drug effect or adverse effect and for predicting absence or presence of the drug effect or adverse effect of the specimen based on matching with the discrimination formula;
and a discrimination formula optimizing part comprising:
a function for appending to the discrimination formula generated by the discrimination formula generating part by addition of the gene condition relevant to the desired threshold value relative to the case count from among the gene conditions extracted by the discrimination formula generating part, and for selecting the gene condition that increases the share rate or case count in the appended overall discrimination formula; and/or a function for selection and deletion of the gene condition increasing the share rate or case count in a decreased overall discrimination formula resulting from reduction from the generated discrimination formula.

2. The drug effect-adverse effect prediction system according to claim 1,
wherein, when the share rate and cases of a first gene condition are shared with the share rate and cases of another gene condition, from among the gene conditions included in the generated discrimination formula, the discrimination formula optimizing part deletes the other gene condition from the generated discrimination formula.

3. The drug effect-adverse effect prediction system according to claim 1,
wherein the discrimination formula optimizing part further comprises:
a function for reading a condition (referred to hereinafter as the “medical knowledge condition”) based on medical knowledge relating to the presence or absence of the drug effect-adverse effect contained beforehand in a database, searching the extracted gene conditions, and subtracting the medical knowledge condition when the extracted gene conditions include the medical knowledge condition;
and a function for adding the medical knowledge condition when the medical knowledge condition is not included in the extracted gene conditions.

4. The drug effect-adverse effect prediction system according to claim 1,
wherein the case analysis table generating part adds to the analysis table data relating to the gene condition of the specimen while classifying the added data concerning presence or absence of the drug effect or adverse effect;
the reliability analysis part reads the analysis table, selects at least one of the gene conditions, and calculates the share rate;
the discrimination formula generating part, based on the desired threshold value for the share rate and the desired threshold value for presence or absence of the case count, extracts the gene condition and generates the discrimination formula using the gene condition alone or the combined gene conditions;
and the prediction part predicts an overall share rate in the generated discrimination formula for an estimated value of the reliability that has been classified relating to presence or absence of the drug effect or adverse effect for the specimen.

5. A drug effect-adverse effect prediction program for using a computer for prediction of a drug effect-adverse effect,
wherein the computer performs:
a case analysis table generating step of generating an analysis table for handling cases related to presence or absence of the drug effect or adverse effect for each of gene condition relating to the drug effect or adverse effect;
a reliability analyzing step of selecting at least one gene condition from among the gene conditions in the analysis table and calculating a share rate of a case count of the presence or absence of the effect or adverse effect;
a discrimination formula generating step, based on a desired threshold value for the share rate and a desired threshold value for presence or absence of the case count,
of extracting of corresponding gene conditions from among the gene conditions having had share rates calculated during the reliability analysis step, and of generating a discrimination formula using a single extracted gene condition or a combination of extracted gene conditions;
a predicting step of prediction relating to the presence or absence of the drug effect or adverse effect of the specimen based on, for each of the gene conditions included in the discrimination formula, comparison checking of data relating the gene condition of a specimen relating to presence or absence of the drug effect or adverse effect, and arranging the discrimination formula;
and a discrimination formula optimizing step comprising: a step of appending to the discrimination formula generated by the discrimination formula generating part by addition of the gene condition relevant to the desired threshold value relative to the case count from among the gene conditions extracted by the discrimination formula generating part, and selecting the gene condition that increases the share rate or case count in the appended overall discrimination formula; and/or a step of selecting and deleting of the gene condition increasing the share rate or case count in a decreased overall discrimination formula resulting from reduction from the generated discrimination formula.

6. The drug effect-adverse effect prediction program according to claim 5,
wherein during the discrimination formula optimizing step, when the share rate and cases of a first gene condition are shared with the share rate and cases of another gene condition, from among the gene conditions included in the generated discrimination formula, the discrimination formula optimizing part deletes the other gene condition from the generated discrimination formula.

7. The drug effect-adverse effect prediction program according to claim 5,
wherein the discrimination formula optimizing step further comprises:
a step of reading a condition (referred to hereinafter as the “medical knowledge condition”) based on medical knowledge relating to the presence or absence of the drug effect-adverse effect contained beforehand in a database, searching the extracted gene conditions, and subtracting the medical knowledge condition when the extracted gene conditions include the medical knowledge condition;
and a step of adding the medical knowledge condition when the medical knowledge condition is not included in the extracted gene conditions.

8. The drug effect-adverse effect prediction program according to claim 5,
wherein the case analysis table generating step adds to the analysis table data relating to the gene condition of the specimen while classifying the added data concerning presence or absence of the drug effect or adverse effect;
the reliability calculating step reads the analysis table, extracts at least one of the gene read conditions, and calculates the share rate;
the discrimination formula generating step, based on the desired threshold value for the share rate and the desired threshold value for presence or absence of the case count, extracts the gene condition and generates the discrimination formula using the gene condition alone or a combination of the gene conditions;
and the prediction step predicts an overall share rate in the generated discrimination formula for an estimated value of the reliability that has been classified relating to presence or absence of the drug effect or adverse effect for the specimen.
